(19) United States
(12) Patent Application Publication
(10) Pub. No.: US 2015/0207786 A1
(43) Pub. Date: Jul. 23, 2015

(54) SYSTEM AND METHOD FOR ELECTRONIC VAULT TO MANAGE DIGITAL CONTENTS

(71) Applicant: Satyan G. Pitroda, Oak Brook, IL (US)

(72) Inventor: Satyan G. Pitroda, Oak Brook, IL (US)

(21) Appl. No.: 14/598,456

(22) Filed: Jan. 16, 2015

Related U.S. Application Data
(60) Provisional application No. 61/928,902, filed on Jan. 17, 2014.

(51) Int. Cl. H04L 29/06; G06F 17/30

(52) U.S. Cl. CPC H04L 63/08; G06F 17/30011

(57) ABSTRACT

Systems and methods are provided for establishing and maintaining an electronic vault to manage digital contents related to the life of an individual and facilitate the authorized transfer of the contents upon the occurrence of a life-changing event of the individual. The disclosure also relates to an electronic vault to manage digital contents for an organization and to facilitate the authorized transfer upon occurrence of an authorizing event from the organization.

### RELATED APPLICATION

This application claims priority to U.S. Prov. Appl. 61/928,902, filed on Jan. 17, 2014, of the same title, which is incorporated by reference in its entirety.

### FIELD

This disclosure relates to a system and method for an electronic vault to manage digital contents related to the life of an individual and facilitate the authorized transfer of the contents upon the occurrence of a life-changing event of the individual. The disclosure also relates to an electronic vault to manage digital contents for an organization and to facilitate the authorized transfer upon occurrence of an authorizing event from or relating to the organization.

### DESCRIPTION OF THE RELATED ART

Many individuals use a bank vault for securing various types of physical assets such as artifacts, jewelry, deeds and other real property documents, share certificates, heirlooms, photographs, and similar items that have monetary, sentimental and or other value to the individual or to members of the individual's friends and family. In last decade, non-physical, digital assets and property have increased in importance, and there is a particular need for new methods and systems of storing personal documentation and other digital information. The growing importance of an individual's or enterprise's digital information has given rise to the concept of the virtual identity, such as embodied for the individual or enterprise on social networks such as Facebook, LinkedIn, Twitter, etc. Like physical assets, digital information is an asset in need of protection.

Furthermore, consider what happens to an individual's digital information after the death of that individual. Those close to the individual, such as family, friends and colleagues, will find it difficult to locate the individual's digital content and retire the virtual identity of the individual. One easy way to do this is to keep the digital content of the individual arranged in the individual's computing device with proper backup. However, the individual's computing device may be stolen or destroyed and received by the incorrect recipient. Banks for quite some time have been recognized as a trusted third party, able to ensure that an appropriate recipient receives items from a physical vault or money from a bank account.

There is therefore a need for a digital content vault to secure, manage, and monitor access to digital information and content, including digital identity, in a single place to protect and simplify retrieval and use by authorized recipients upon a life-changing event of an individual, including death or disability of the individual.

### SUMMARY

Methods and systems are provided herein for establishing an electronic storage vault to store electronic content related to an individual. A tangible and transferrable receipt for the electronic storage vault may be created, the receipt providing evidence of ownership of the electronic storage vault and allowing access to the electronic storage vault of a person upon presentation of the tangible and transferrable receipt. The electronic content for the individual may be managed and made available to at least one authorized stakeholder upon presentation of the receipt by the stakeholder. Content services may be provided to the at least one authorized stakeholder, and the electronic content may be transferred to the authorized stakeholder, such as upon the occurrence of a life-changing event of the individual. Electronic content may be selected from a group of metadata relating to of physical documents, items in digital form, metadata of digital documents, original physical documents, items in various digital forms an original digital document, or some other source. Electronic content may be associated with physical content.

A stakeholder may be selected from the group consisting of an individual, an executor, a trustee, a guardian, a guardian ad litem, an agent, a health care proxy holder, a nominee, a digital content vault service provider, a service provider, a financial institution, a nominee, a trustee, a digital notary, a submitter, a government and a court, or some other type of stakeholder.

A service provider may be selected from the group consisting of a notary service provider, certificate authority service provider, a provider of legal services, a bank, trust company, insurance company, a financial services provider, or some other type of service provider.

Content services may be selected from the group consisting of digital vault services, alert services, digital content services, digital safe services, nomination services, digital post box services, or some other type of content service.

Digital vault services may be selected from the group consisting of access services, management services, activation services, deactivation services, or some other type of digital vault service.

Digital content services may be selected from the group consisting of create services, manage services, or some other type of digital content service.

Digital safe services may be selected from the group consisting of access services, create services, nomination services, manage services, or some other digital safe service.

Digital post box services may be selected from the group consisting of access services, add services, retire contents services, or some other type of digital post box service.

In embodiments, an electronic storage vault may be established to store electronic content related to an organization. A tangible and transferrable receipt for the electronic storage vault may be created, the receipt providing evidence of ownership of the electronic storage vault and allowing access to the electronic storage vault of a person presenting the tangible and transferrable receipt. The electronic content for the organization may be managed and made available to at least one authorized stakeholder. Content services and the receipt may be provided to the at least one authorized stakeholder and the electronic content transferred to the authorized stakeholder upon the occurrence of an authorizing event of the organization and upon the presentation of the receipt.

An authorizing event may be a lawful request from an executive or a board of governors of an organization.

In embodiments, an electronic storage vault may be established to store electronic content related to an individual or organization. A tangible and transferrable receipt may be created for the electronic storage vault, the receipt providing evidence of ownership of the electronic storage vault and allowing access to the electronic storage vault of a person. The electronic content of the electronic storage vault may be managed and made available to at least one authorized stakeholder. Content services may be provided to the at least one authorized stakeholder and the electronic content transferred to the authorized stakeholder upon the occurrence of an authorizing event and upon the presentation of the receipt.

The electronic storage vault may store electronic content related to an individual and an authorizing event may be death or an incapacitating illness of the individual.

In embodiments, the physical content may be documents, such as a will, a trust document, a tax planning document, a health care proxy, a set of instructions, family information, ancestry information, personal journals, personal secrets, legacy information (e.g. a secret recipe or a message to a particular individual), or any other kind of information valued by an individual.

These and other systems, methods, objects, features, and advantages of the present disclosure will be apparent to those skilled in the art from the following detailed description of the preferred embodiment and the drawings. All documents mentioned herein are hereby incorporated in their entirety by reference.

### BRIEF DESCRIPTION OF FIGURES

FIG. 1 is an illustration of a digital content vault system according to an exemplary and non-limiting embodiment of the present disclosure;

FIG. 2 is an illustration of the utility of a digital content vault upon the death of the owner according to an exemplary and non-limiting embodiment of the present disclosure;

FIG. 3 is an illustration of digital content create services and digital content manage services according to an exemplary and non-limiting embodiment of the present disclosure;

FIG. 4 is an illustration of services provided by a digital safe according to an exemplary and non-limiting embodiment of the present disclosure;

FIG. 5 is an illustration of a manage service provided by a digital post box according to an exemplary and non-limiting embodiment of the present disclosure;

FIG. 6 illustrates a digital content vault architecture according to an embodiment of the present disclosure according to an exemplary and non-limiting embodiment of the present disclosure;

FIG. 7 is an illustration of a digital content vault architecture according to an exemplary and non-limiting embodiment of the present disclosure;

FIG. 8 is an illustration of a digital content vault use case according to an exemplary and non-limiting embodiment of the present disclosure;

FIG. 9 is an illustration of a digital content vault architecture according to an exemplary and non-limiting embodiment of the present disclosure;

FIG. 10 is an illustration of a digital vault activation/deactivation use case according to an exemplary and non-limiting embodiment of the present disclosure;

FIG. 11 is an illustration of a digital vault activation/deactivation use case according to an exemplary and non-limiting embodiment of the present disclosure;

FIGS. 12A and 12B are illustrations of a manage vault use case according to an exemplary and non-limiting embodiment of the present disclosure;

FIG. 13 is an illustration of a manage safe use case according to an exemplary and non-limiting embodiment of the present disclosure;

FIG. 14 is an illustration of a manage safe use case according to an exemplary and non-limiting embodiment of the present disclosure;

FIG. 15 is an illustration of a create/manage stakeholder use case according to an exemplary and non-limiting embodiment of the present disclosure;

FIG. 16 is an illustration of a create/manage digital content use case according to an exemplary and non-limiting embodiment of the present disclosure;

FIGS. 17A and 17B are illustrations of a manage postbox use case according to an exemplary and non-limiting embodiment of the present disclosure;

FIGS. 18A and 18B are illustrations of a manage uploadbox use case according to an exemplary and non-limiting embodiment of the present disclosure;

FIG. 19 is an illustration of an alert system use case according to an exemplary and non-limiting embodiment of the present disclosure;

FIG. 20 is an illustration of a notarize contents use case according an exemplary and non-limiting embodiment of the present disclosure;

FIG. 21 is an illustration of a manage account use case according to an exemplary and non-limiting embodiment of the present disclosure; and

FIG. 22 is an illustration of a manage password use case according to an exemplary and non-limiting embodiment of the present disclosure.

FIG. 23 is an illustration of a nominee/confidant creation and management use case using the digital content vault system according to an exemplary and non-limiting embodiment of the present disclosure;

### DETAILED DESCRIPTION

In embodiments of the present disclosure, methods and systems are provided for a digital content vault for managing digital content, including the digital identity, of an individual, in a secure place, to simplify retrieval by authorized recipients upon a life-changing event of an individual. The digital content vault may maintain various personal digital content (information) to assist and protect a person from various problems and challenges, such as limited mental capacity, memory limitation, disorganization, reluctance to share plans with other individuals, a desire for privacy, and so forth. For example, the digital content vault may generate or trigger a periodic or one time reminder to an individual to protect the individual from the memory limitation of the individual to safe guard the digital content of the individual. The digital content vault may protect important digital content (records) that may also be held in paper form against loss or destruction and to maintain a copy of the paper form as a digital copy for reference purposes. The digital content vault may receive digital content (documents), on behalf of the individual, from pre-specified e-mail addresses or people with document upload rights, for the individual to arrange them, immediately, or later, such as at a convenient time. The digital content vault may protect important digital content also held in paper or card form against loss, theft, destruction, and other disasters. The digital content also held in paper or card form may be stored with evidence of legal validity. Legal validity may be established, for example, through digital notarization for maintaining authenticity for legal purposes, and in other established ways, such as a contract between an owner and a provider of digital content vault services.

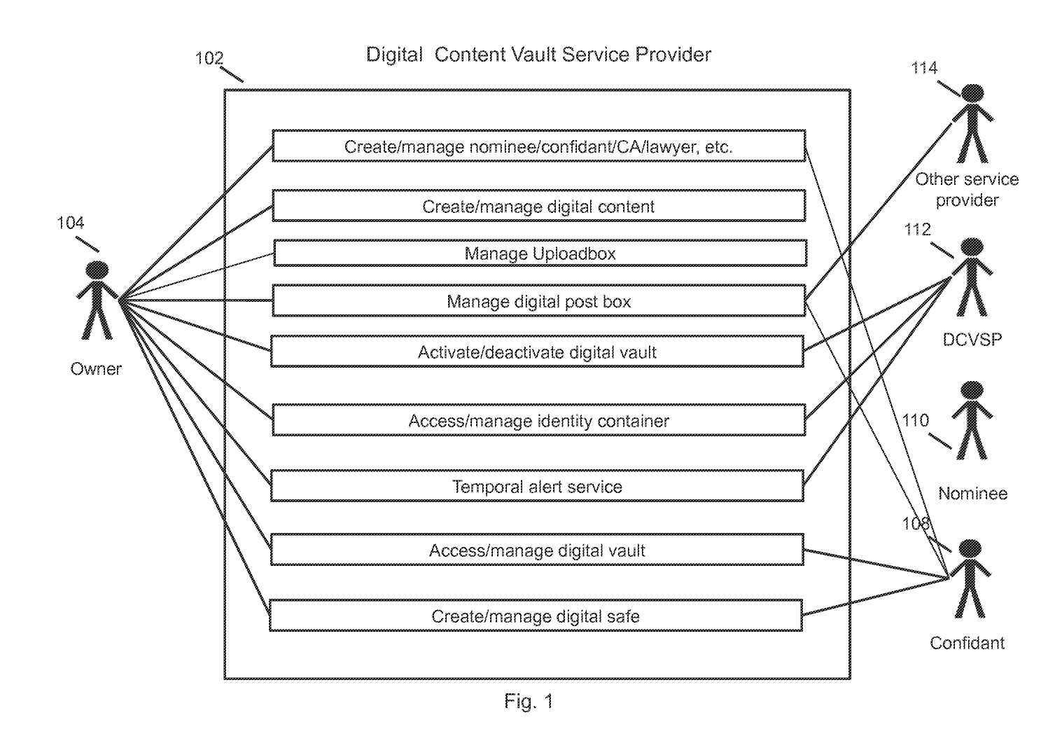

With reference to FIG. 1, there is illustrated a digital content vault system according to exemplary and non-limiting embodiments. The digital content vault may provide services 102 to a variety of stakeholders. Stakeholders may include an owner 104, an heir, a relative, a spouse, a guardian, a proxy, a trustee, a confidant 108, a nominee 110, a digital content vault service provider 112 and other service providers 114, and the like. The owner may authorize a party, such as a confidant, to view the contents of the digital content vault. Other service providers may include a notary service provider, certificate authority (CA) service provider, legal services provider, etc. Services may include digital vault services, alert services, digital content services, digital safe services, nomination services, digital post box services, etc. Digital vault services may include access services, management services, activation services, deactivation services and other related services. Identity container services may include access services, management services. Alert services may include temporal alert services 120. Digital content services may include creating services and managing services, among others. Additionally, services may include uploadbox management services.

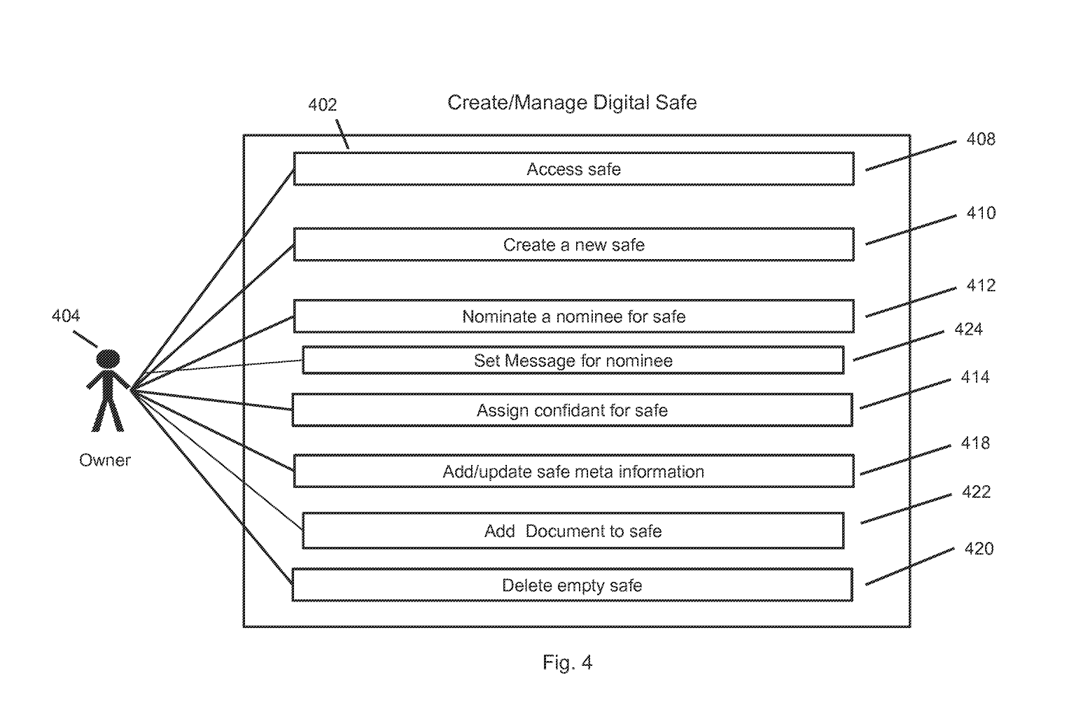

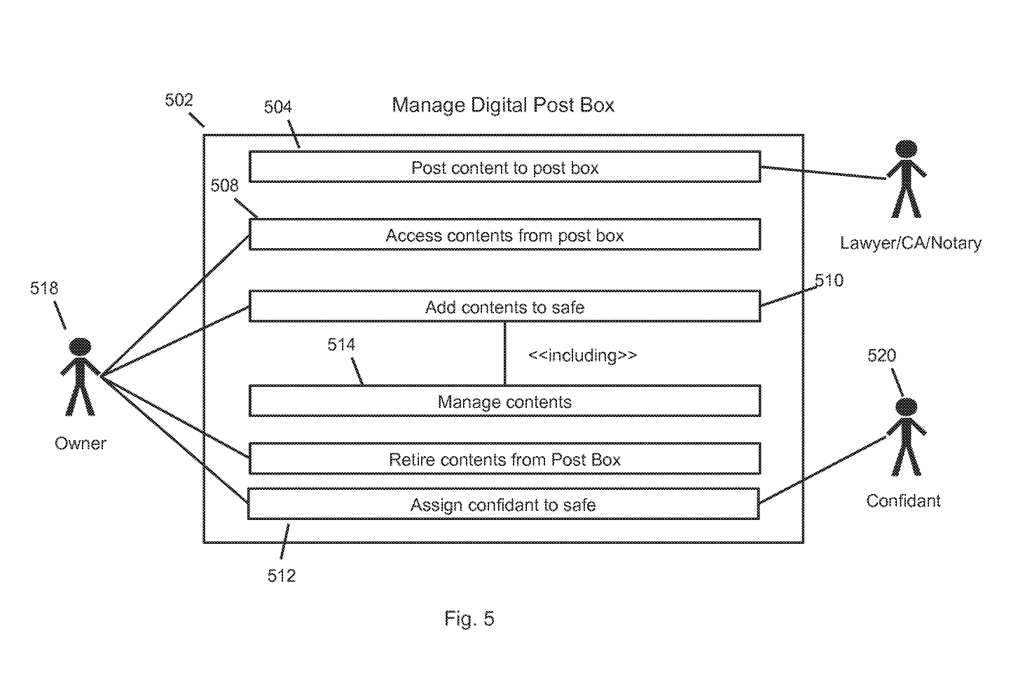

As illustrated in FIG. 4, digital safe services 402 may be provided to the owner 404 and may include access services 408, creation services 410, nomination of a nominee for safe services 412, assignment of a confidant for safe services 414, management services, add/update safe metadata services 418 and deletion of empty safe services 420, add documents to safe services 422, and set a message for nomination services 424. Nomination services may include creation services and deletion of empty safe services. Digital post box services may include managing digital post box services. As illustrated in FIG. 5, management of digital post box services 502 may include posting of content to post box services 504, accessing of contents from post box services 508, adding contents to safe services 510 and retirement of contents from post box services 512. Adding contents to safe services may include management of contents services 514. A nominee may be informed in advance, or may be unaware that they are a nominee until such time as a life changing event occurs. This may allow a person to plan actions, such as after the person's death, that are put into motion for a nominee after the death, where the nominee may then have access to the digital content vault. A confidant 520 may be informed by the owner 518 that they are registered as a confidant to share a safe in the digital content vault of the owner. A safe may be a shared safe or an exclusive safe. The owner can give access rights to a shared safe to a confidant to allow the confidant to view the contents of the safe. There may be more than one confidant or more than one confidant for each shared safe.

The identity container may contain the digital identities of the owner, such as ones that the owner has on various social network sites where the owner participates. The owner may have other personal identities, such as digital signatures, encryption keys, and so forth. The identity container may also function as a password container. A password container may contain the passwords, keys, PINs, IPINs, and the like of various accounts, cards and services that the owner holds. Cards may be credit cards, debit cards, loyalty cards and ATM cards, and so forth. Services may be memberships of web services, applications, and the like.

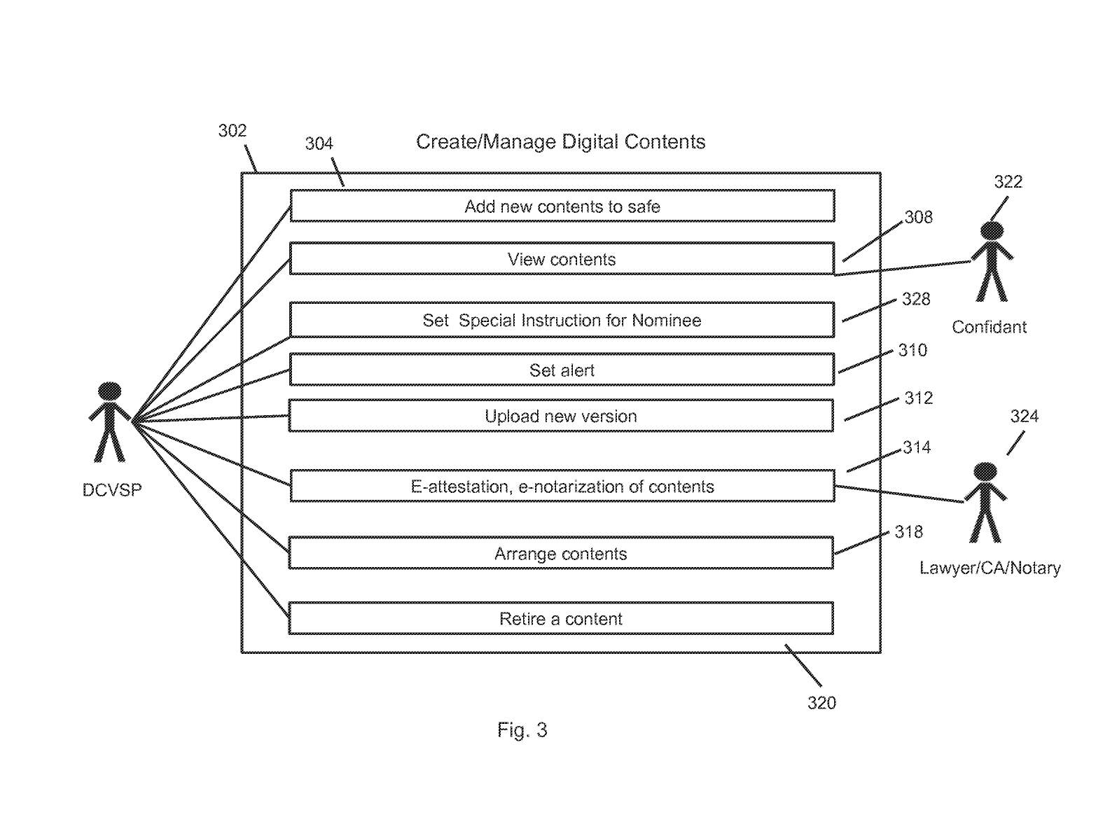

FIG. 3 illustrates digital content creation services and digital content management services 102 according to embodiments of the present disclosure. Digital content creation and management services may include adding new contents to the safe 304, viewing contents 308, setting alerts 310, uploading new versions 312, e-attestation and e-notarization of contents 314, arrangement of contents 318 and retirement of content 320, and setting special instructions for a nominee 328. Digital content creation and management services may be provided to an owner, confidant 322, lawyer, health care or other proxy, power of attorney, trustee, agent, certificate authority, notary 324, or the like and to others selected by the owner or his or her agent. New versions may be uploaded from the desktop of the owner, the post box of the owner, or other source of documents.

The digital content vault system may provide certain functions, such as when there is a life-changing event related to the owner. The digital content vault may provide a function to maintain important, valuable and useful personal digital contents in an organized and highly protected way in the digital content vault of the owner. The digital content vault may be provided by a digital content vault service provider. The digital content vault system provided by the digital content vault service provider may protect the owner from losing important data due to theft, loss, misplacement, accidental destruction, memory loss, etc. The digital content vault system may provide a function to facilitate the organization of digital contents. The digital content vault may be composed of a set of digital safes to store different digital contents as per the choice of the owner. The establishment of a digital content vault may require at least a single digital safe. The digital content vault may provide a function to enable the owner to dynamically create additional digital safes. Digital safes may be exclusive digital safes or shared digital safes. The digital content vault may provide a function to provide primitives to put digital content in any of the digital safes to read, copy, or retire an existing piece of digital content. In embodiments, no digital content is deleted from a safe (i.e., content is preserved in the safe and deletion is prevented). In embodiments, digital content may be retired or may be outdated by uploading a new version of the digital content. The owner may view all earlier versions of digital content, retired digital content, and associated documents and instructions.

The digital content vault may provide a function to maintain the records of a confidant. The digital content vault may provide a function to maintain the records of a list of confidants. The records may have associated messages. The records and messages may be stored in a digital safe. The digital safe may be designated by the owner. The owner may authorize the content of a digital safe to be accessed by a confidant. The digital content vault may provide a function to permit a confidant of the shared digital safe to access (read and copy only) the digital contents of the shared digital safe through a secured access control mechanism. The digital content vault may provide a function to provide a mechanism of a temporal alert service to be tagged by the owner with different digital content, as and when required. The temporal alert service may send single alerts or periodic alerts. The digital content vault may provide a function to receive digital contents in a digital post box from pre-specified e-mail addresses having upload rights, for the owner or confidante to arrange them later in the different digital safes owned by the owner.

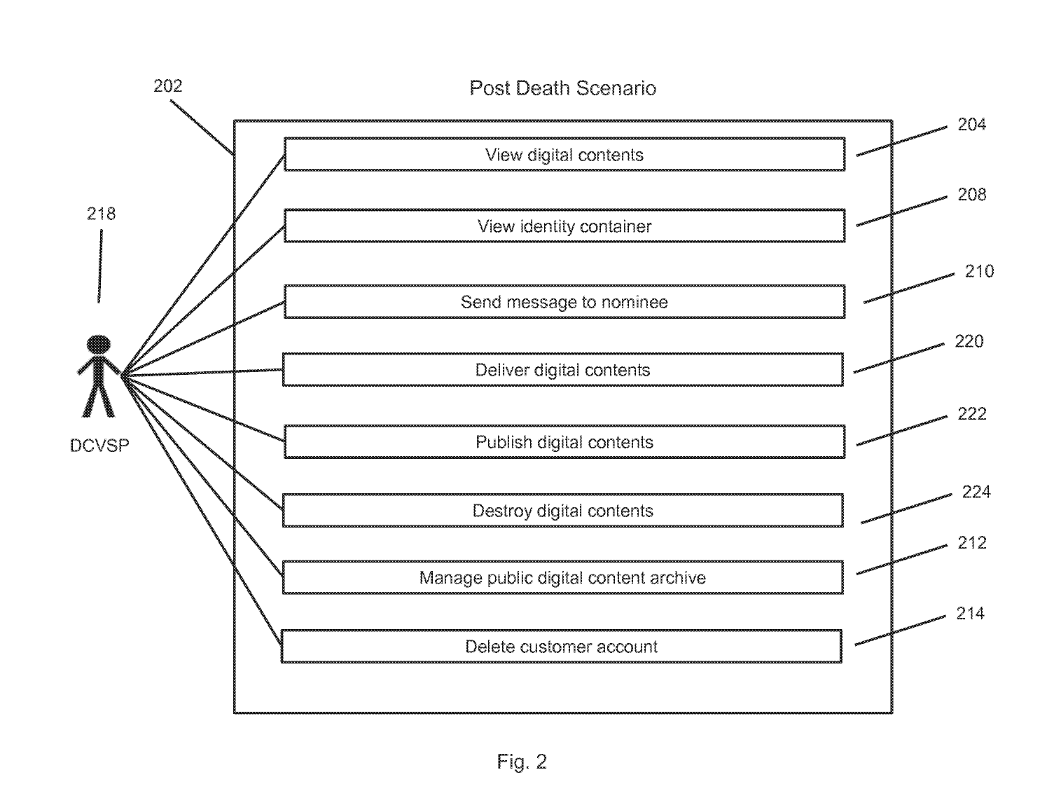

With reference to FIG. 2, the life changing event of the owner may be the death of the owner. The digital content vault may provide services 202 in a post-death scenario of the owner. The digital content vault may provide a service to deliver contents of each digital safe to a designated nominee or multiple nominees. The contents of each digital safe may be delivered with an associated message from the owner.

Upon a life-changing event, for those digital content items where the digital vault service provider has been named the nominee, the digital vault service provider may follow the instructions given by the owner. The instructions may be to destroy the digital content, publish the digital content, convey the digital content, or other instructions as desired. The instructions may be written as a part of messages relating to the contents of those digital safes. The digital content vault service provider may be designated as the nominee of the digital safe by the owner. The digital content vault may provide a service to maintain a public digital content archive for those contents that have been requested by the owner to be made public after the death of the owner. The digital content vault may provide a service to terminate a customer account of the owner after delivering all contents of all the digital safes of the owner to their respective nominees. These services may also be made available to an organization, as well as an owner, if the organization is closed, for example.

With continued reference to FIG. 2, the digital content vault may provide digital content services. Digital content services may include viewing services, delivery services 220, publishing services 222 and destruction services 224, among others. Viewing services may include viewing digital contents services 204 and viewing identity container services 208. The digital content vault may provide other services. Other services may include sending a message to a nominee 210, managing a public digital content archive 212 and deleting a customer account 214. The digital content vault may be provided by a digital content vault service provider 218. The digital content vault service provider may safely keep the contents of the identity container upon life-changing events of the owner and rules. Rules may be specified by the owner's country, a country foreign to the owner, and by other authorized agents. If the owner is an organization, such as a corporation, LLC, non-profit, or some other type of entity, the life-changing event may be a board resolution, bankruptcy, dissolution, change of control, merger, or some other type of life-changing event of an organization. The board resolution may instruct the digital vault service provider to make a super nominee of the digital content vault the owner of the digital content vault or close the account and destroy the contents of the account in the case the organization is being closed, or may provide other instructions.

An important part of the present disclosure is authority and authorization from an owner of the digital content. As noted, the owner may be an individual or an organization. There may be more than one owner, e.g., a group of owners or partners. It may be important in some situations that the provider of digital content vault services be authorized by the owner or owners to take any of the actions or services that the digital content vault service provider undertakes to do. This may be evidenced in one or more of many ways, such as by a contract or an agreement. It may also be convenient at a later time to produce evidence of such authority. Thus, it is recommended for the owner or owners to provide a tangible and/or transferrable receipt for the contents of the electronic storage vault, the receipt providing evidence of ownership of the electronic storage vault and allowing access to the electronic storage vault of a person presenting the tangible and/or transferrable receipt. The receipt may take any reasonable form, such as an executed contract or agreement in writing on one or more pieces of paper. Alternatively, a receipt could take a form of an object. For example, a metal key in earlier times provided evidence of a person's ownership of a safe or a strong box. A more modern equivalent may be a token providing a continuously or periodically changing passcode for a two-factor authorization system, e.g., a SecurID token from RSA Corp. Other tokens and other methods and systems may be used, but requiring a physical object provides an extra measure of security for the contents of the digital vault. The token provides a second required passcode to access an electronic site or file.

The digital content vault may have stakeholders. Stakeholders may include owners, financial institutions, confidants, digital notaries, submitters, governments, courts and lawyers, among others. The owner of a digital content vault may be an individual, several individuals, a partnership or an organization. The owner may be a custodian of the digital asset maintained in the digital content vault. A financial institution may be the digital asset vault service provider, which maintains the vault and provides other services to the owner and conveys information to various nominees. The financial institution may be a bank or a trust. Nominees may be persons nominated to receive the digital asset by the owner in case of death and life changing event. The nominees may be associated with a digital asset vault and details may be maintained by the financial institution. The financial institution may communicate with the nominee in case of a death or other life-changing event. A digital notary may be a legal entity who notarizes a digital asset for authenticity. A submitter may use e-mail addresses or website access permission permitted by owner to submit or upload digital assets in document form to the post box. A government may provide governing acts and rules applicable for the management of the digital vault. A court may provide dispute resolution in case nomination is not provided by owner or any other scenario. A lawyer may perform actions on behalf of an owner as desired after the death of the owner.

The digital content vault may be deployed as an Internet service where an owner can access the services through any Internet browser. The digital content vault may have various safes. Each safe may be empty, may have a single item or may have a plurality of items. The digital content vault may have a predefined safe. The digital content vault may have a provision to define a safe. The owner may drag and drop the predefined items into the safe. The owner may fill in information to the item templates and add documents to the items. The owner may save the items at a clipboard and when completed may save it in the digital content vault. A digital content item saved in a safe may not be able to be deleted. A new version of the digital content items with modified information can be saved. The digital content vault may have both versions of the items. The digital content vault may only display the latest one. A revision history of each item may be maintained by the System.

The digital content vault may have a provision to provide access for e-attestation or e-notarization, such as to or by the authorized person. The digital content vault may have a provision where an owner can provide limited access, such as view only access, access to a list or table of contents, or the like, to an external entity. In embodiments, there may be separate areas for view and e-attestation. Items that are provided with view or attestation access may be available in limited fashion, such as being available only in the view or attestation area. Items that have cyclic event information may have a facility for raising an alert to an owner through mail. In embodiments, the owner may assign nominees to the vault or safe level. The system may have a digital authentication service. An owner may request this service by putting items for this service. There may be a separate area for an authentication service.

In embodiments, the digital content vault may contain various items of many types. For example, items may be metadata relating to physical documents or items in digital form, metadata relating to digital documents, original physical documents, items in various digital forms (including original digital documents) and the like. In embodiments documents have digital signatures.

The digital content vault may have functionality to keep a document in an enhanced secure manner. An enhanced secure manner may be an encrypted mode. An encryption and decryption key may be a combination of an owner key and a digital content vault key. The system may provide a mechanism for the owner to create an encryption key for the digital content vault. The identity container may store a copy of an owner key in secure manner in the key repository for usage by nominees. Access to the key may be conditioned on life events related to the owner. For example, a host of the methods and systems described herein may pass a key to a designated party, such as an heir, upon a life event, such as the death or disability of the owner of the vault.

The system may have the facility to define an owner account as a professional account. In the case of a professional account, the owner may have functionality to define multiple vaults, where each vault is dedicated to a specific purpose, such as to one of a set of individuals, such as clients. For example, an attorney managing estates of multiple clients may manage a vault for each client. In embodiments, each vault may multiple safes, where multiple items can be safely stored. If the owner for a digital vault is an organization or a company, the company may be represented by an individual who may function as the owner of the digital vault. The professional account may have multiple vaults, each vault may have its own safes, and each safe may have a set of confidants. In embodiments, there may be one super nominee for the total set of vaults and the super nominee be a party other than the vault service provider. The super nominee may be changed by the owner dynamically. In embodiments, there may not be any other nominee for any of the safes in such a vault.

The life changing event for an organization may be a board resolution of the organization that may instruct the vault service provider to make the super nominee of a particular vault the owner from that instant onwards, or to close the account and destroy the contents, such as in case the organization is being closed or in the case of other situations or events.

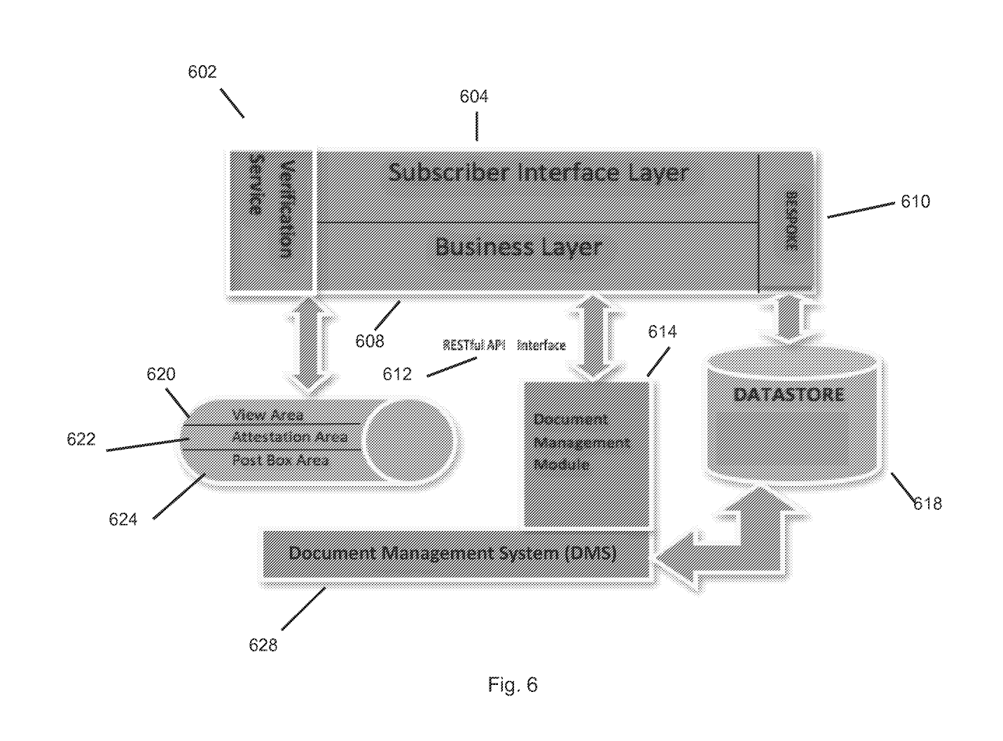

FIG. 6 illustrates a digital content vault architecture according to an embodiment of the present disclosure. The digital content vault may include verification services 602, an owner interface layer 604, a business layer 608, a bespoke application 610, a RESTful API interface 612, a document management module 614, a data facility, such as a database 618, a view area 620, an attestation area 622 and a post box area 624. The digital content stored in the digital content vault may have a document associated with it. Accordingly, the digital content vault may include a document management module 628. The document management module may be a document management system (DMS). The DMS may use a database to provide its service. The DMS may be a Nuxeo DMS. The database may be a MySQL database, Oracle database, Postgres database, or other database. The database may support XML as a native data type. The majority of internal data may be, for example, XML format data. The database may be an open source database. The key management and owner related access may be managed through a key management protocol, such as the Light Weight Directory Access Protocol (LDAP). Communication with the digital content vault may be secured primarily over SSL. The bespoke application may be built in Java, .Net, or other programming language. In embodiments, the owner interface may be tile-based.

In embodiments, the digital content vault architecture may include remote mobile device support and at least one software application on the mobile device, within a network, wherein the detection occurs within a distributed computing environment that includes computing and storage facilities that are remote to the mobile device.

In embodiments, data used by, or associated with, digital content vault architecture may derive from a plurality of distributed data storage repositories, processors, databases, CPUs, and other types of computing architecture components.

In embodiments, data used by, or associated with, the digital content vault architecture may derive from a plurality of distributed computing devices, including laptop computers, PCs, PDAs, tablets, smart phones, cellular phones, television set-top boxes, navigation systems, personal fitness devices and monitors, or some other type of distributed computing device.

In embodiments, the digital content vault architecture may be deployed in different data venues including, but not limited to, the Internet, enterprise data systems, distributed storage, cloud-based storage, or some other data source or repository.

In embodiments, the digital content vault architecture may be deployed across a plurality of network types, including but not limited to a cellular network, the Internet, an enterprise network, a home network, a telecommunications network, or some other type of computing network, each of which may be associated with a device. The device may be dedicated to the given computing network, or it may be a multi-purpose computing device capable of operation across a plurality of network types. For example, a tablet device may be enabled to operate on the Internet and also be enabled to access a cellular network.

In embodiments, the digital content vault architecture may process, store, compute and distribute digital contents instantaneous or near-instantaneously, for example while inputting data to the digital content vault architecture, accessing data within the digital content vault architecture, and/or releasing data from the digital content vault architecture. This instantaneous or near-instantaneous processing, storage, computing and distribution may enable large volumes of data to be processed, stored, computed and distributed at such a high rate of speed that, for example, that real time activities of a user of the digital content vault architecture may be processed, stored, computed and distributed in a manner that traditional methods and systems could not. For example, a user of a smart phone may elicit geocode information as the user moves geographically. While moving geographically, the user may perform activities or behaviors on a smart phone, such as placing phone calls or utilizing the internet, that generate data that is relevant to digital assets intended to be stored within the digital content vault architecture, but which could not be manually processed or processed instantaneously or near-instantaneously using traditional methods and systems.

In embodiments, the digital vault may facilitate users protecting digital assets and digital copies of important records in other forms, such as in paper, for reference purposes against loss, destruction, or other undesirable outcomes. Additionally, the digital vault may manage digital contents related to the life of an individual and facilitate the authorized transfer of contents to an assigned nominee upon the occurrence of a life-changing event.

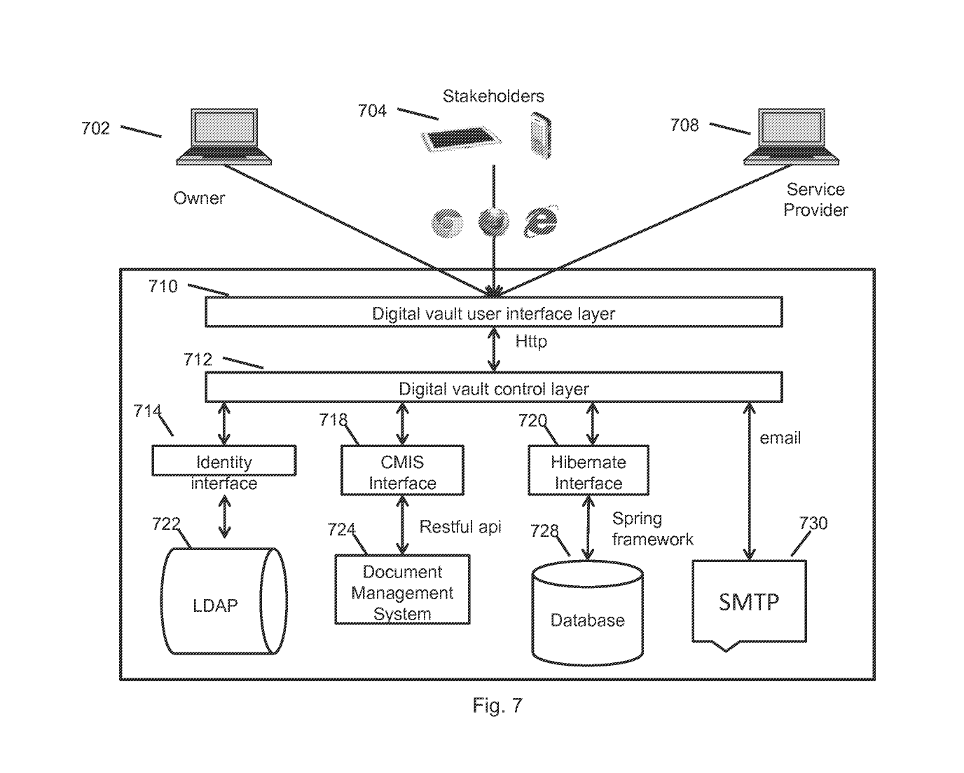

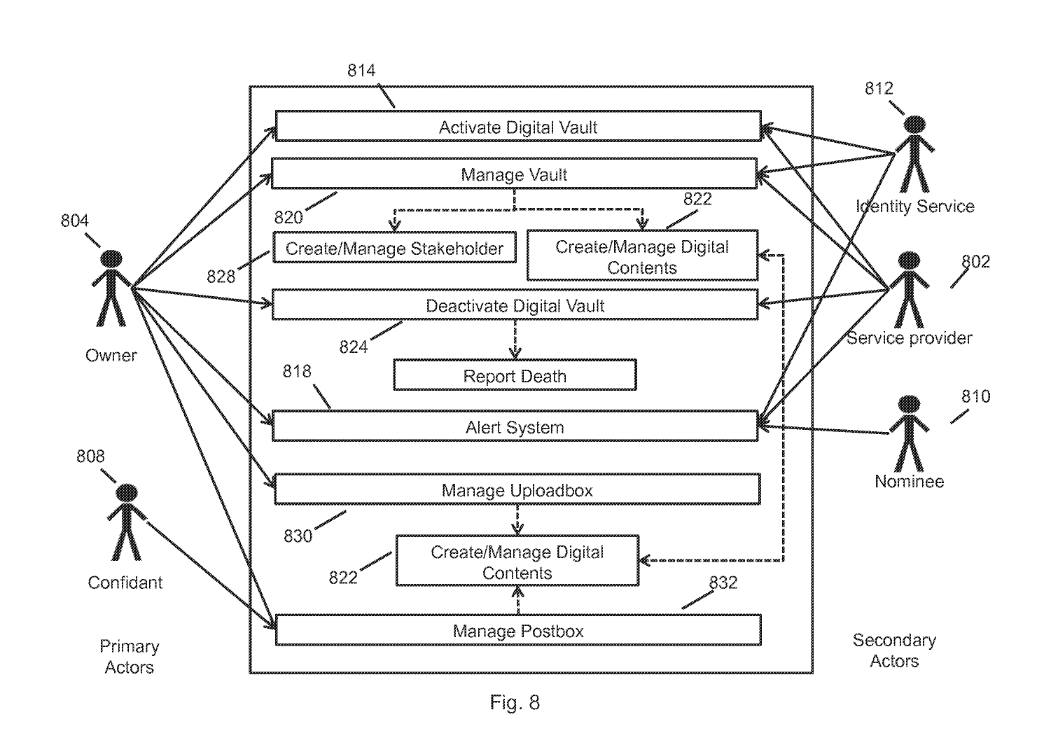

In embodiments and in FIG. 7, the digital vault may comprise a user interface layer 710, a controller layer 712, an identity interface 714, a CMIS interface 718, and a hibernation interface 720. The user interface layer may enable interactions between the digital vault, stakeholders (via a network such as the internet) 704, an owner 702, service provider 708, and other users. The user interface layer may interact with the controller layer via a protocol such as, but not limited to, hypertext transfer protocol. The controller layer may interact with the identity interface, the CMIS interface, and the hibernation interface. The identity interface may interact with lightweight direct access protocol directory services 722. The CMIS interface may interact with a document management system 724 via a service such as, but not limited to, a RESTful API. The hibernate interface may interact with a database 728 using a framework such as, but not limited to, a Spring framework. The controller layer may provide email and other communication services via a protocol such as, but not limited to, Simple Mail Transfer Protocol 730. Users may interact with the user interface layer using a variety of different devices, such as a desktop computer, mobile device, and the like. Users may use internet browsers in order to access the digital vault.

In embodiments, the user interface layer may be deployed via a user's internet browser. The user interface layer may contain all boundary classes that represent application screens. The user interface layer may respond to the user's behavior and environment based on screen size, platform, and orientation, among others. Users may access screens from any device, regardless of screen size. The user interface layer may deploy an HTML5/CSS3 media query to deliver a website in different versions depending on the capabilities and specifications of the end user device via JavaScript/Ajax, among other web development techniques. Small resolution or smaller screen devices may receive content with full functionality, just like high resolution or larger screen devices. The controller layer, or operation layer, may contain all the controller classes that drive the application behavior. The layer may represent the client-to-mid-tier border. The identity interface may be responsible for authentication and authorization of a user. The interface may depend upon the Lightweight Directory Access Protocol System (LDAP). The LDAP System may be responsible for managing user accounts and profiles. The digital vault may support other identity interfaces, so any service provider may use any identity system or their own identity system for authentication. The CMIS interface may be responsible for the Document Management System (DMS). The CMIS interface may use Alfresco as a DMS, among others. The interface may be responsible for managing the digital vault, managing the digital safe, managing the postbox and upload box, and managing the digital contents. Clustering may be deployed with high availability of load balancing. The hibernation interface may support access to relational DMBS. The hibernation interface may be an open source, lightweight, Object Relational Mapping tool. The hibernation interface may use Mysql, ostgres, Oracle services, or some other database management system.

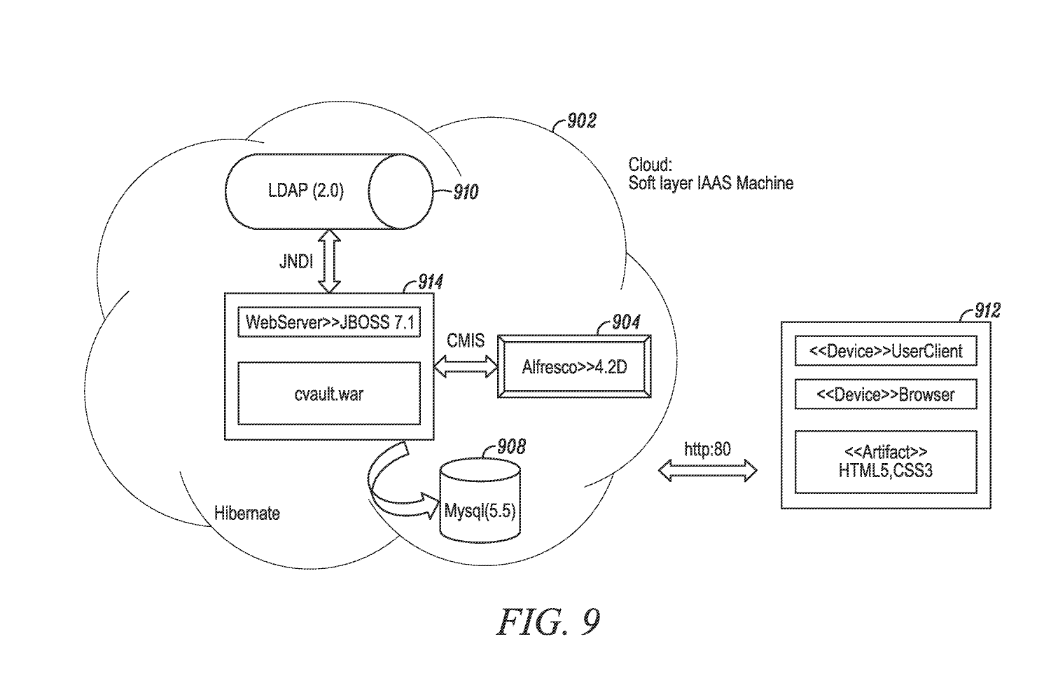

In a non-limiting example as shown in FIG. 9, the digital vault may be deployed as a Web Archive file into at Jboss 7.1 container 914 with a cloud configuration as a soft layer IAAS Machine 902. The digital vault may use Java and JSP as its languages and use Alfresco as its document management server 904. The digital vault may use Mysql as database server 908 and LDAP as identity server 910. The digital vault system may be, in an example, deployed on Bare Metal environment. Users may be restricted to access the digital vault online using browsers 912 such as Mozilla Firefox 10, Internet Explorer 9, or other latest versions of internet browsers.

In embodiments, a plurality of persons or other external entities may interact with the digital vault system. In a non-limiting example shown in FIG. 8, a service provider 802, such as a bank, may maintain the digital vault system and provide other services to the owner and convey information to various nominees and confidants. The owner 804 may be the owner of digital assets maintained in the vault. Confidants 808 may be individuals such as an executor, a trustee, a guardian, a layer, a tax-authority, or various government actors, among others. The owner may authorize the confidant to view the contents of the digital vault and digital safe shared by the owner. Confidants may post documents to the owner postbox. Nominees 810 may be individuals nominated to receive the digital assets by the owner in case of death or a life changing event. The details of the nominee are maintained by the owner. Nominees may be associated with the owner's digital vault.

The service provider may communicate with the nominee in case of death or a life changing event. In cases where a nominee is not selected, then the service provider may act as a nominee. An identity service 812 may be responsible for authentication and authorization for each entity or user. In embodiments, the service provider may maintain user information in the digital vault system. This may include adding, modifying, and deactivating users from the system. To create a new digital vault account, the service provider may register a new user request with all information and then send the user a confirmation key for activating the account 814. In embodiments, the alert system 818 may allow a service provider to send alerts to the digital vault users. In embodiments, the digital vault may allow a user to maintain and manage the digital vault 820, including adding, modifying and assigning a nominee with a corresponding message to the digital vault.

In embodiments, the digital vault may be used to create, inform, or manage stakeholders. In embodiments, the digital vault may allow users to notarize content. In embodiments, the digital vault may allow a user to maintain the digital safe, including adding, modifying, deleting, and assigning the nominee with corresponding messages. Additionally, the digital safe management service may assign a confidant for each safe. In embodiments, the digital vault may allow a user to manage digital contents 822 in each digital safe, including adding contents from the uploadbox and postbox as well as deleting contents from the safe. In embodiments, the digital vault may allow a user to maintain the digital password of the digital vault, including adding, modifying, deleting user passwords in a secure manner. The digital vault may allow a user to manage stakeholders 828, such as adding, modifying, and deleting a nominee.

Additionally, users may be able to invite and deactivate a confidant in the digital vault system. In embodiments, the digital vault may allow a user to maintain a postbox 832, including securing content to a specified digital safe and sending them to the upload box for other action. Additionally, confidants may post digital content to a corresponding owner postbox. In embodiments, users may maintain the upload box 830, including adding content from the user's desktop, modifying, deleting, and securing them to a digital safe. The digital vault may allow a user to deactivate the digital vault 824. A service provider may report the death or life-changing event for a user and deactivate the user account, deliver contents of each digital vault and digital safe to the designated nominees along with the associated messages. In the event of the death or life changing event for a confident, the digital vault may send a message to all users associated with that confidant.

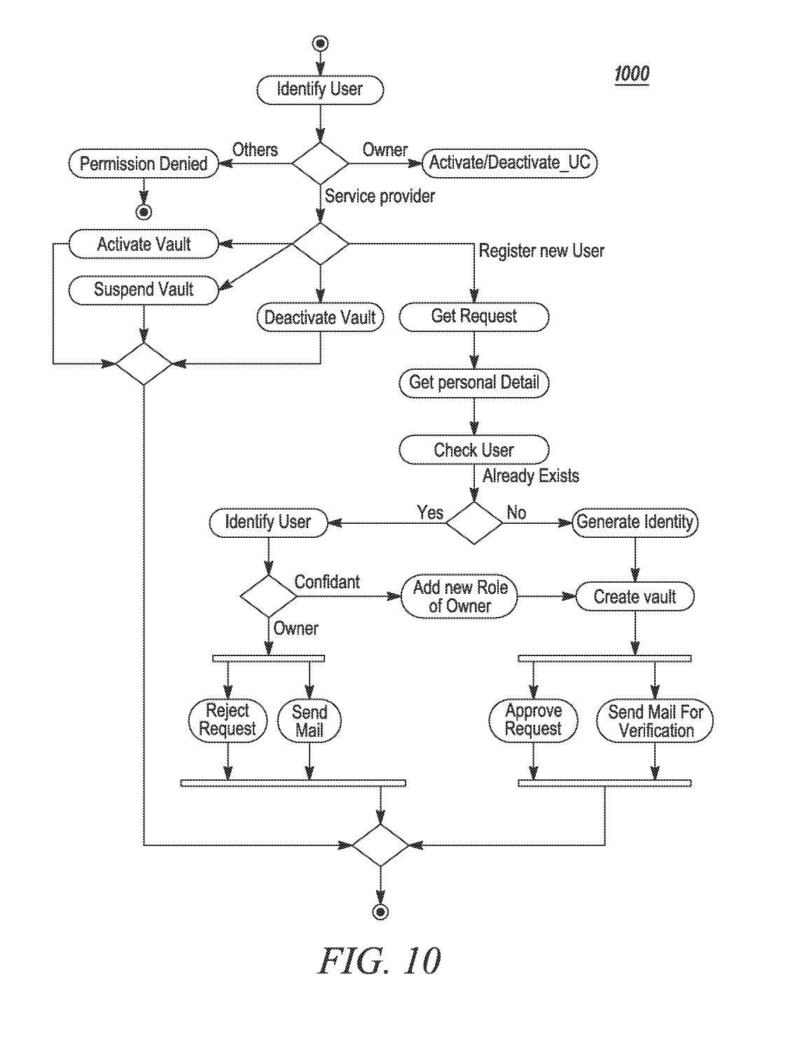

In embodiments, and in FIG. 10, users may deactivate or activate new vaults 1000. The digital vault may identify the user as an owner, service provider, or other. Individuals that are determined to not be either an owner or service provider will not be allowed to activate or deactivate the vault. Service providers may be able to activate, suspend, or deactivate the vault, as well as register new users. The service provider may register a new user by entering personal details. The digital vault may check to see if the user already exists. If the user already exists, then the user may be identified as either a confidant or owner. Users who are already confidants may have the new role of an owner associated with their identities. Owners may receive the request or accept the request. If the user does not already exist, the digital vault may generate a new vault and send mail to the user to approve the request or verify the account.

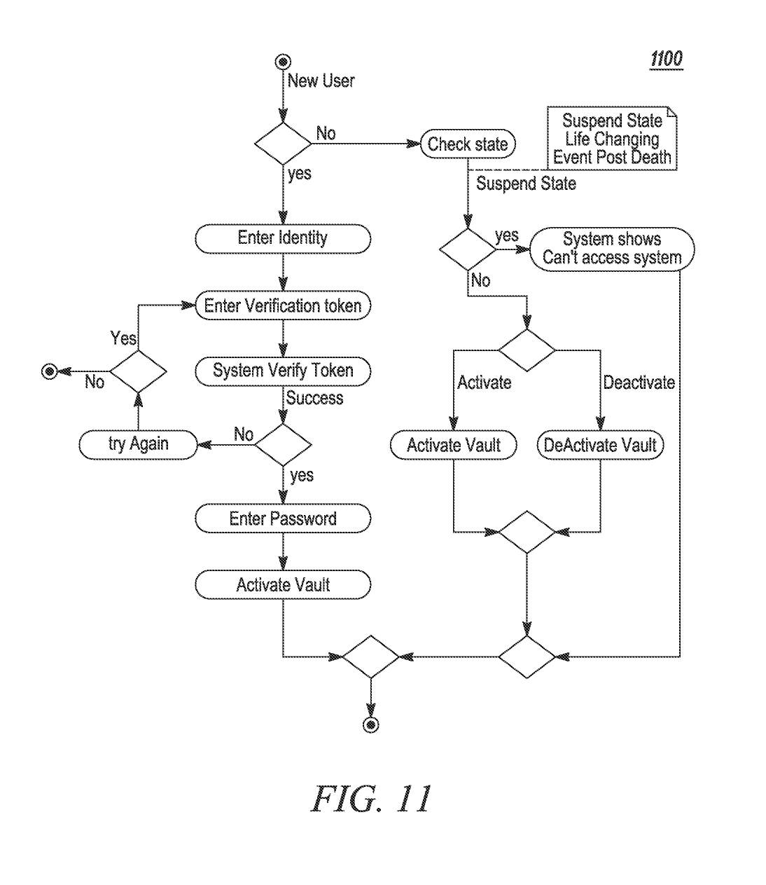

In embodiments, including as depicted in FIG. 11, the digital vault may allow a user-controlled deactivation or activation process 1100. The digital vault may check if a user is new. If the user is new, the individual's information may be identified. New users may be sent tokens to verify the user's identity, and the digital vault may verify the token. If a token is verified, the new user may be able to create a password and activate his or her digital vault. If the user is not a new user, the digital vault may check the state of the user. If the user has experienced a life changing event or if the vault or if the user's account is being accessed post death, the account may be suspended and the system may show that the digital vault may not be accessed. If the user's digital vault is not suspended, the user may be able to activate or deactivate the vault.

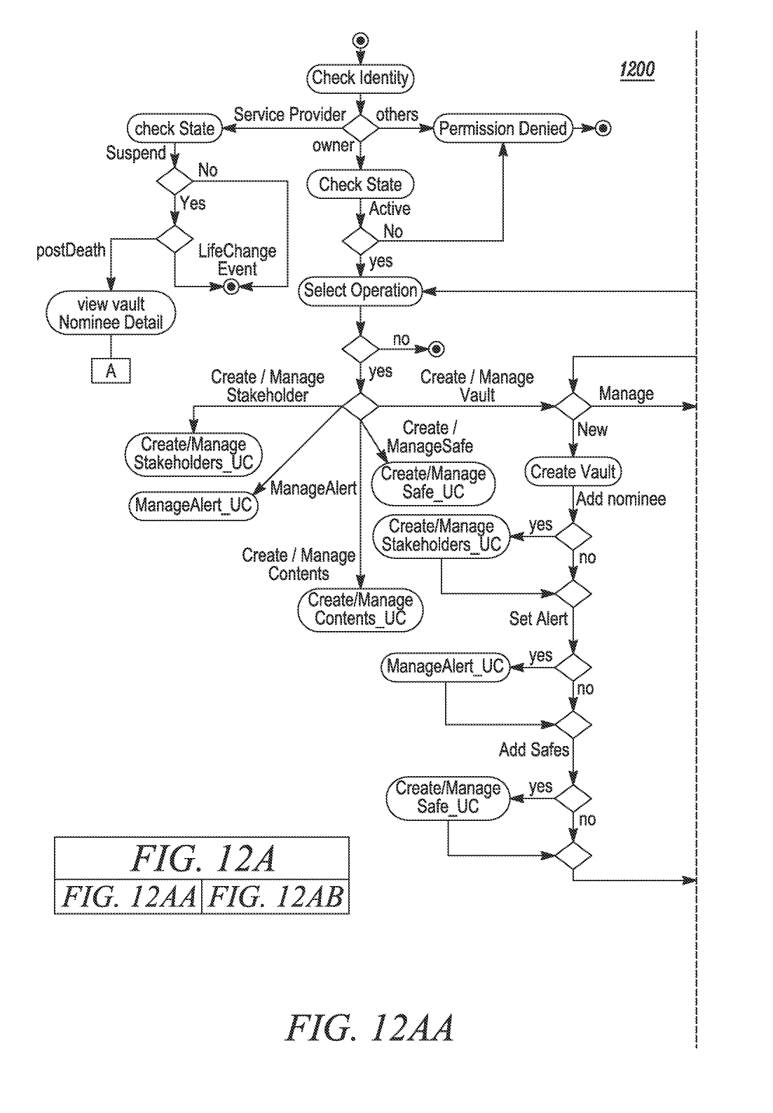

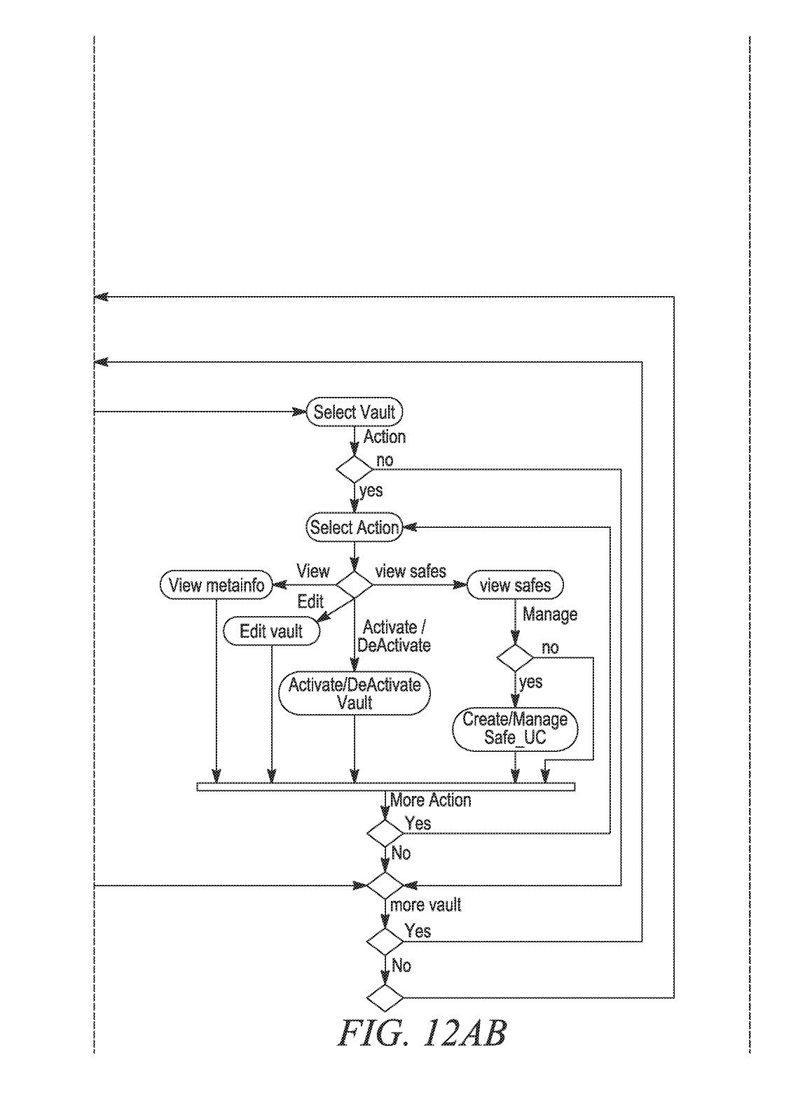

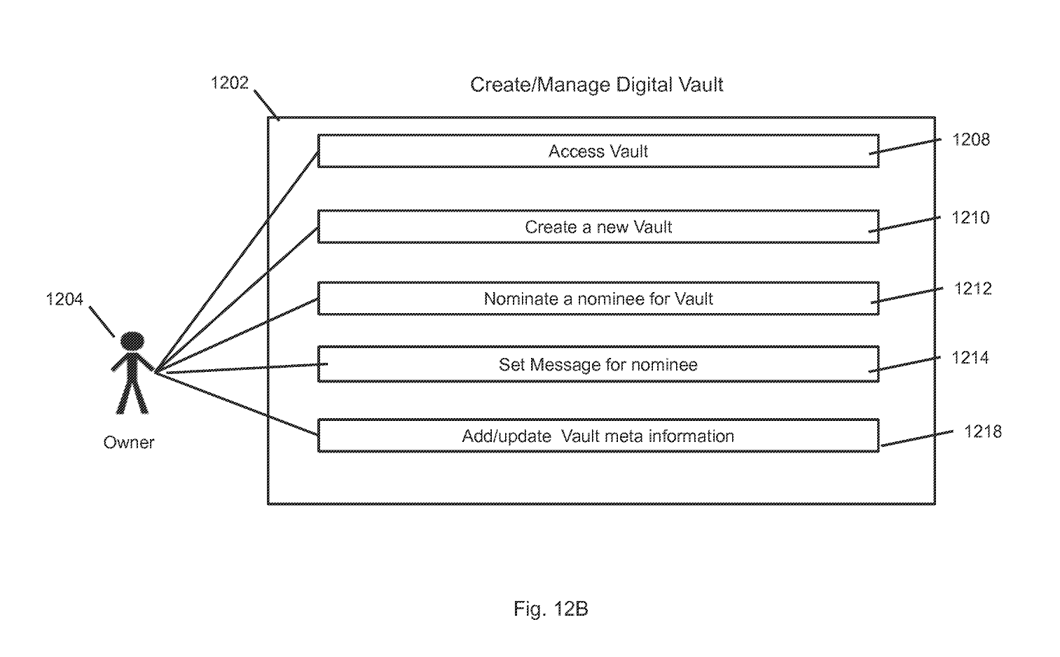

In embodiments, as depicted in FIG. 12A, users may manage 1200 the digital vault. Service providers may be able to check the state of the user. If the user's digital vault has been suspended because of death or life changing event, the service provider may be able to view the vault and any nominee details. Owners of the vault may be able to create/manage new stakeholders, manage alerts, manage the contents of the vault, manage the safe or create new vaults. Owners of the vault may be able to create new vaults with additional nominees, additional alerts, and additional safes. Additionally, owners may be able to view the metainfo of currently active vaults as well as manage safes within those vaults, active or deactivate those vaults or the create or manage safes.

In embodiments and as illustrated in FIG. 12B, digital vault services 1202 may be provided to the owner 1204 and may include access services 1208, creation services 1210, nominate a nominee for vault services 1212, set a message for nomination services 1214, and add/update vault meta information services 1218.

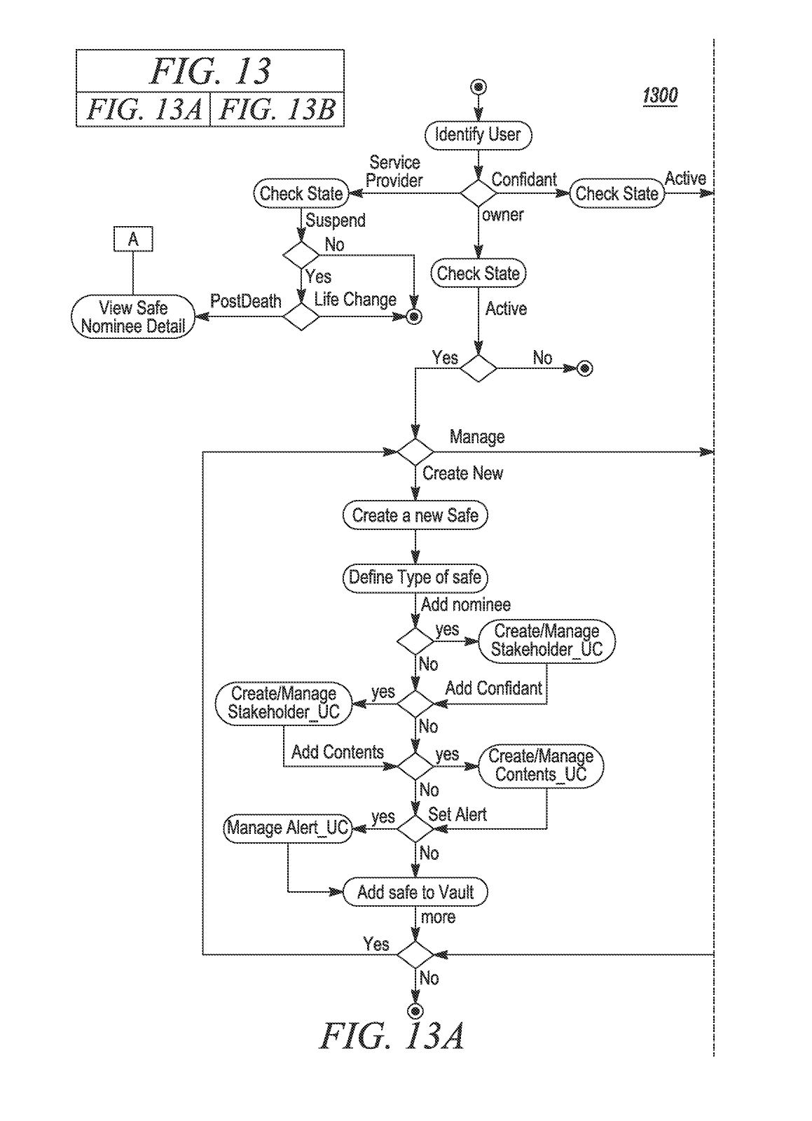

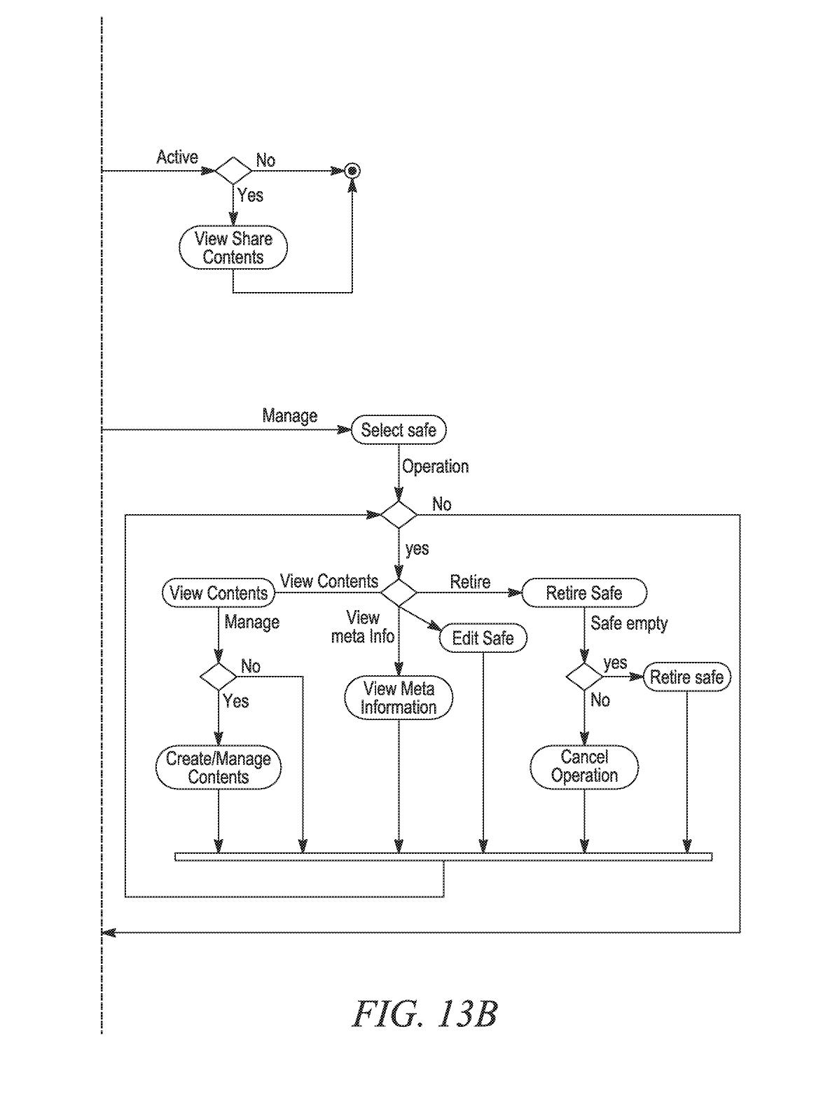

In embodiments and in FIG. 13, users may manage their safes 1300. Service providers may be able to check the state of the user. If the user's digital vault has been suspended because of death or life changing event, the service provider may be able to view the vault and any nominee details. Confidants may be able to check the safe and if active, may view the shared contents of each safe. Owners may be able to create new safes, defining the type of safe, adding nominees, adding confidants, adding contents, and setting alerts. Owners may also be able to select currently active safes, view contents, manage contents, view metainfo, edit safes, or retire safes.

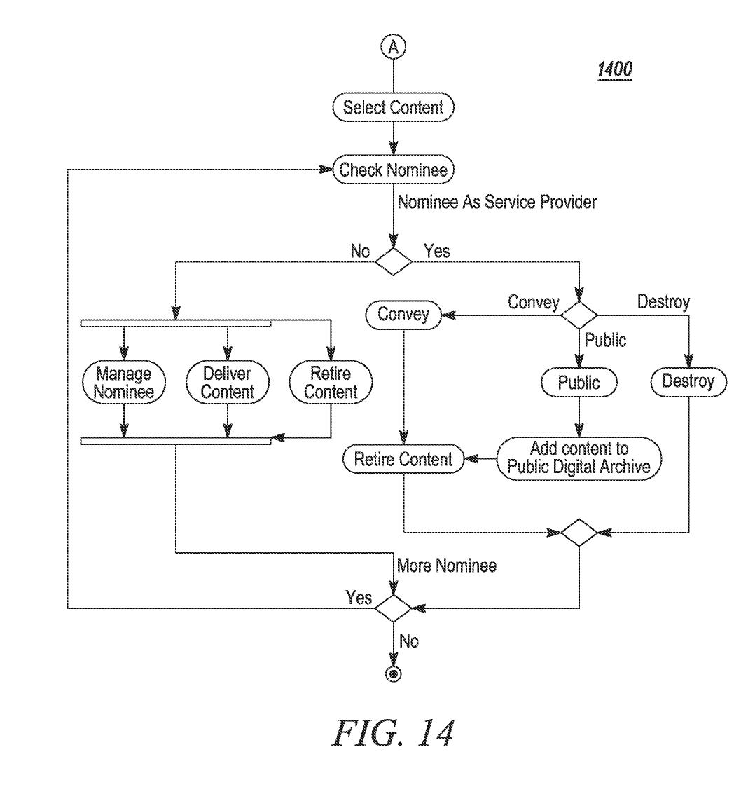

In embodiments and in FIG. 14, users may select the service provider as a nominee 1400. If the nominee is not a service provider the digital vault may allow users to manage other nominees, deliver content and retire content. If the nominee is a service provider, users may convey content, retire content, destroy content, or add content to the public digital archive.

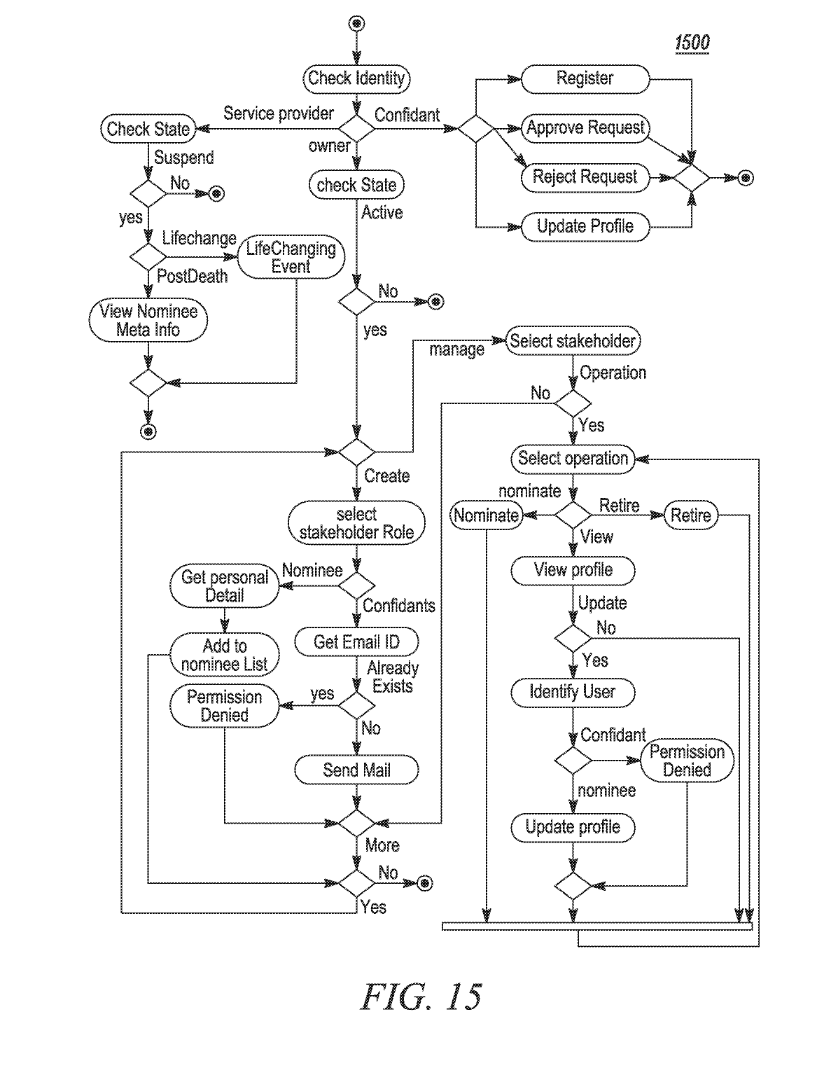

In embodiments and in FIG. 15 users may create and/or manage stakeholders 1500. Service providers may be able to check the state of the user. If the user's digital vault has been suspended because of death or life changing event, the service provider may be able to view the vault and any nominee details. Confidants may be able to register, approve or reject requests, and update their profiles. Owners creating new stakeholders may be able to select whether stakeholders are nominees or confidants. Confidants may be identified and new confidants may be sent mail to notify them of their appointment. Confidants may be identified by their email. An owner may be able to add the personal information of a nominee in order to add the individual to the nominee list. Owners that wish to select currently existing stakeholders may choose to nominate, retire, or view the profiles of current stakeholders. Owners may also update the profiles of existing nominees.

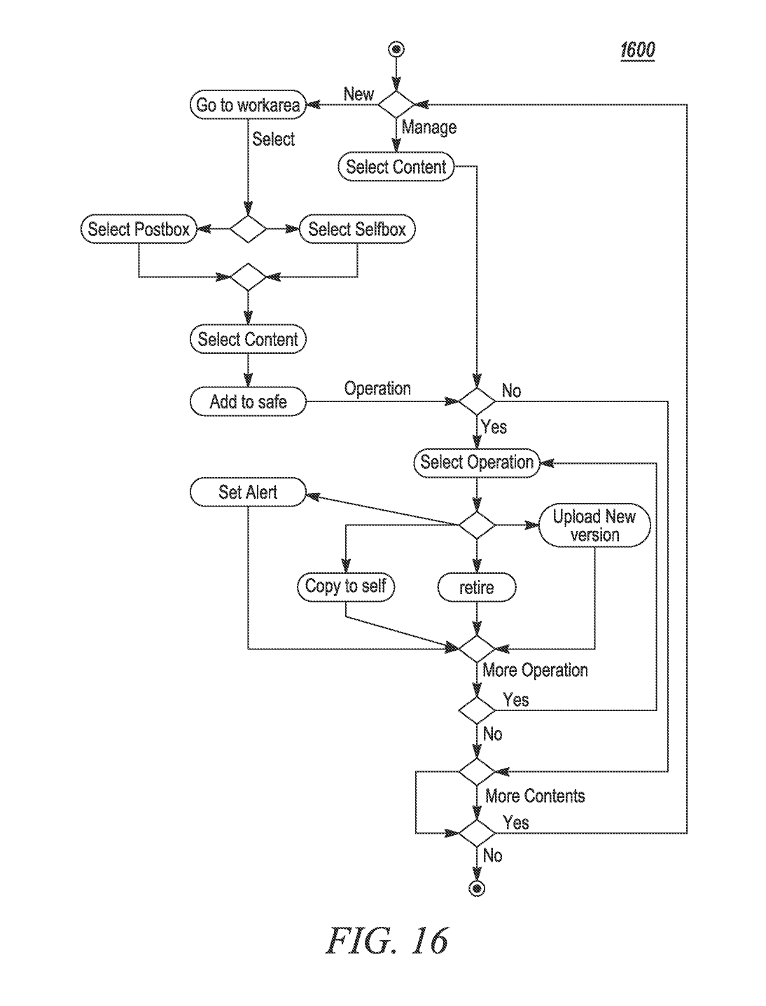

In embodiments, as depicted in FIG. 16, users may create and/or manage the contents of a digital vault 1600. Users may create new content and select whether the content is an uploadbox or a postbox. Created content may be added to a safe. Additionally, the user may set alerts, retire, copy for his or herself, or upload new versions of content already created.

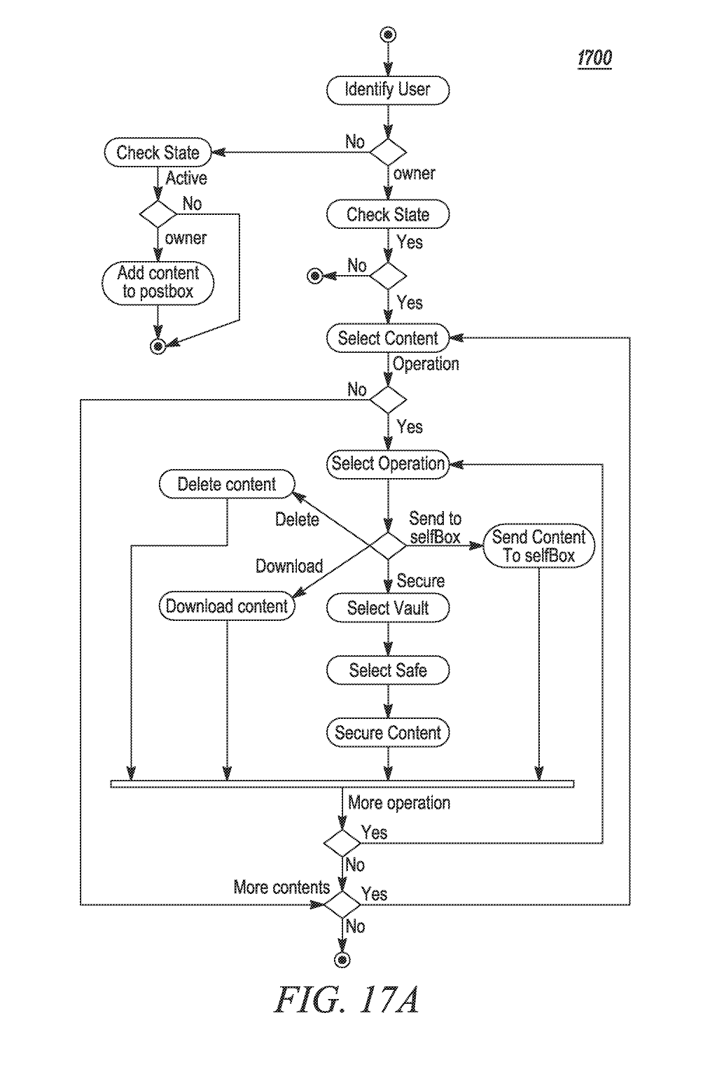

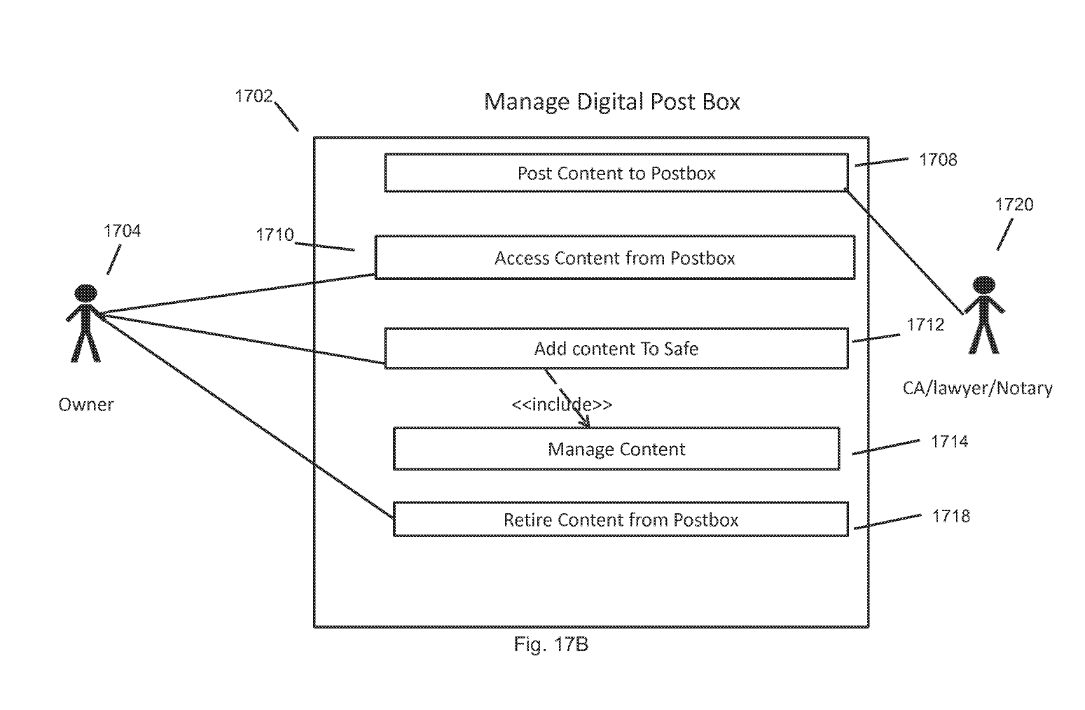

In embodiments, as depicted in FIG. 17A, the digital vault may allow users to manage a postbox 1700. Owners may select content to be deleted, downloaded, secured, or sent to the uploadbox. Postbox materials may be secured to different vaults and different safes. Other individuals may add content to the owner's postbox.

In embodiments and as illustrated in FIG. 17B, digital postbox management services 1702 may be provided to the owner 1704 and may include post content to postbox services 1708, access content services 1710, add content to safe services 1712, which may include content management services 1714, and content retirement services 1718. Other users 1720 may post content to the postbox such as a lawyer, a notary, or a certificate authority, a bank, trust company, insurance company, a financial services provider, among others.

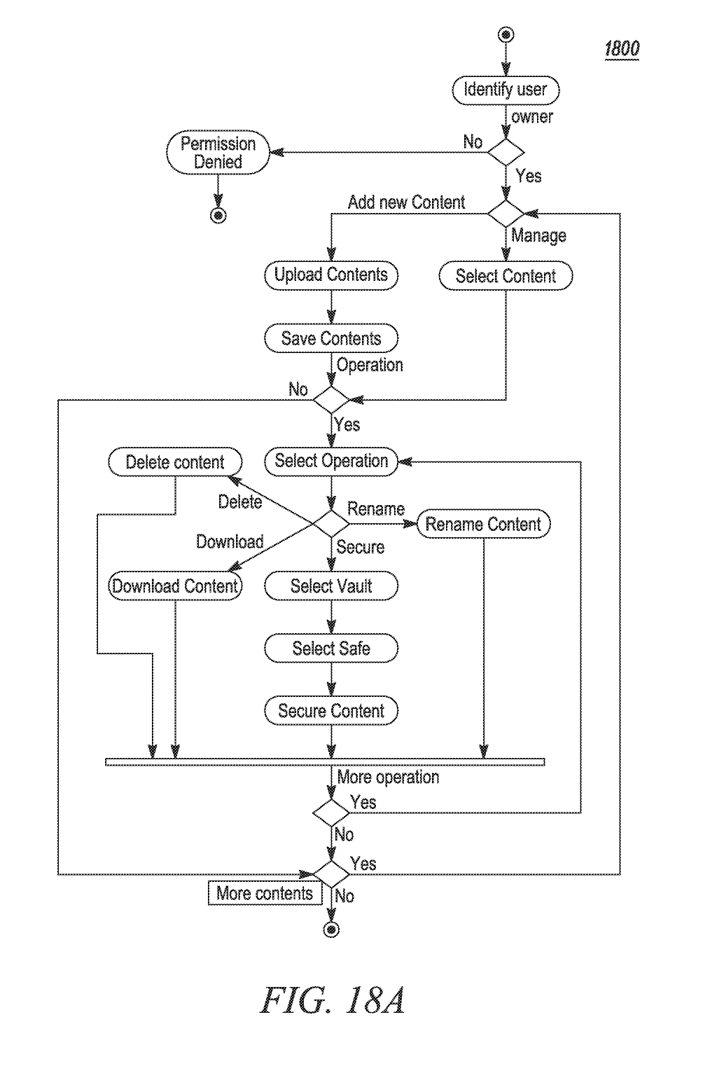

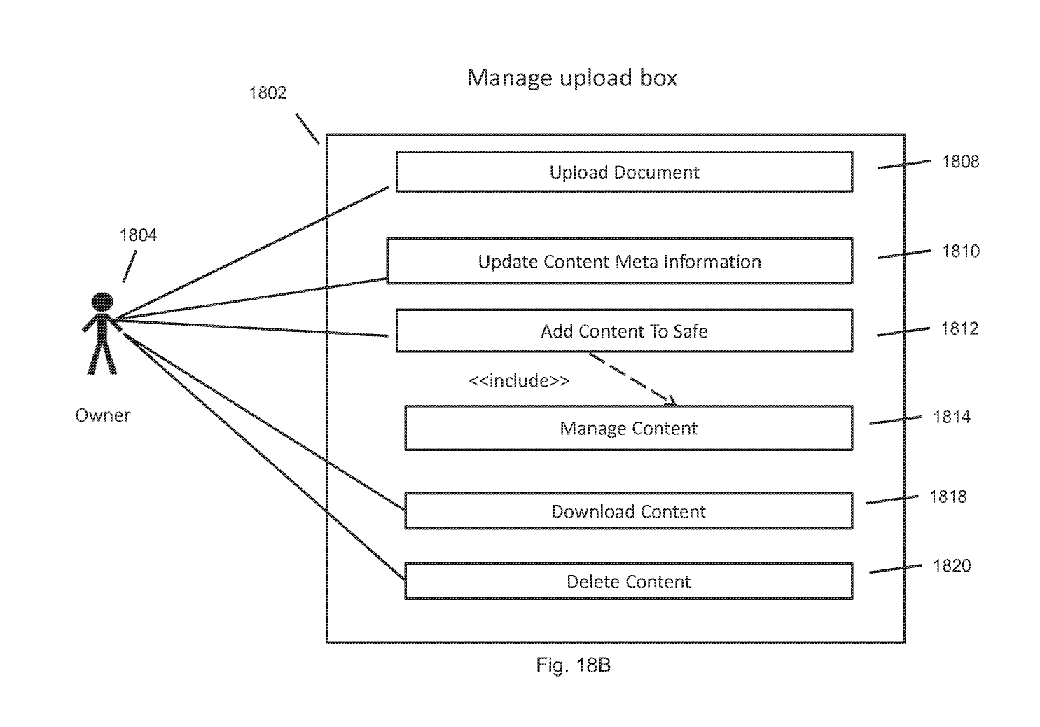

In embodiments, as depicted in FIG. 18A, users may manage the upload box 1800. Only owners may access the upload box. New content can be uploaded and saved to the content and existing content may be managed. The owner may delete, download, rename or secure the content to different vaults or different safes.

In embodiments and as illustrated in FIG. 18B, uploadbox management services 1802 may be provided to the owner 1804 and may include document upload services, 1808, content meta information update services, 1810, add content to safe services 1812 which may include content management services, 1814, content download services 1818, and content deletion services, 1820.

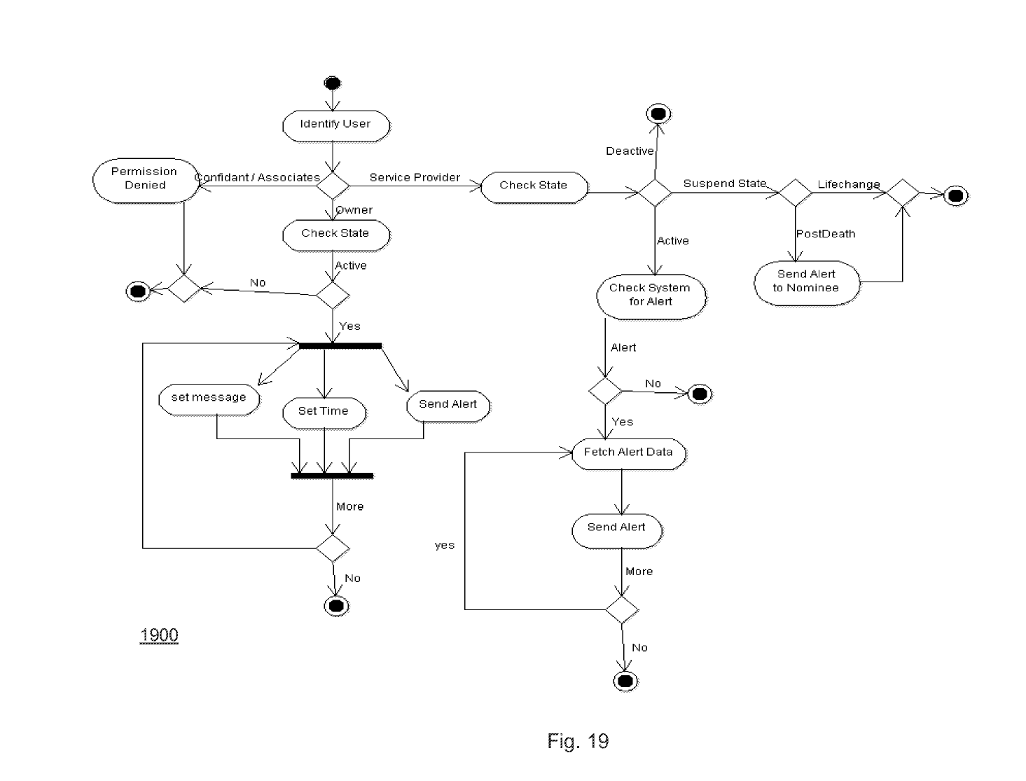

In embodiments and in FIG. 19, the digital vault may comprise an alert system 1900. In embodiments, confidants and other associates may be blocked from being able to access the alert system. Service providers may be able to access the alert system to check the state of the digital vault. If the vault is active, service providers may be able to access alert data and send alerts. If the vault is suspended due to death, the service provider may send alerts to nominees. Owners may be able to set messages, times, or send alerts.

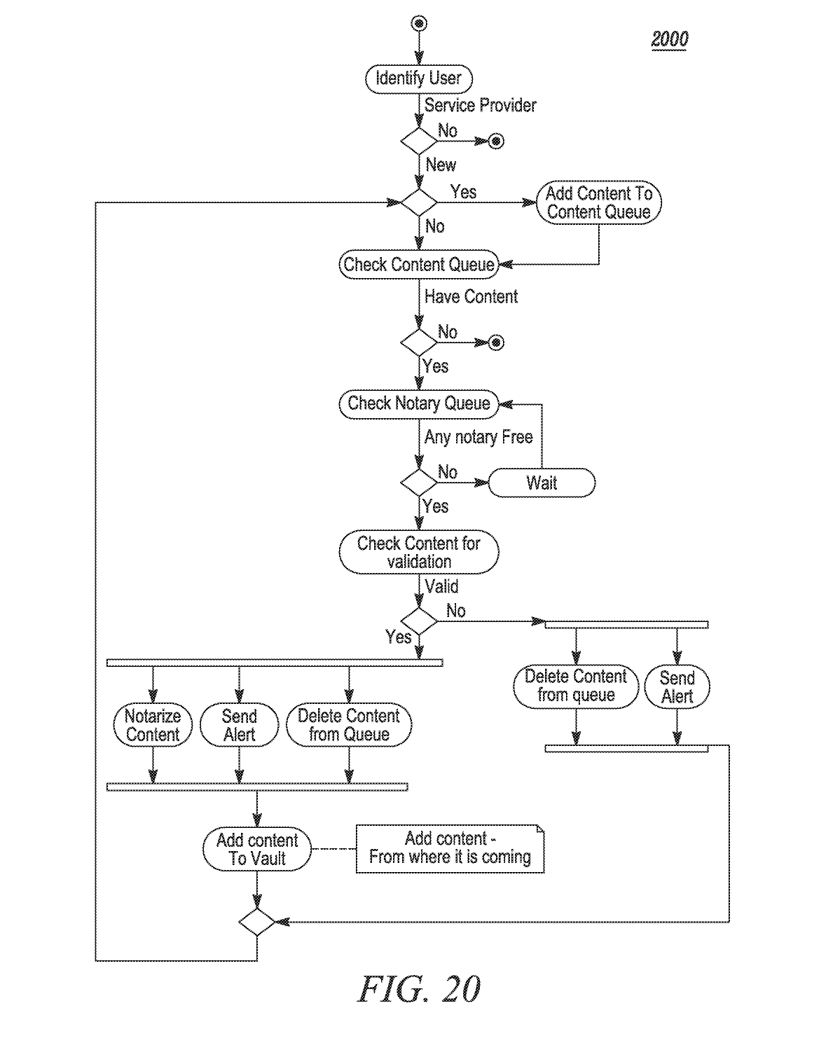

In embodiments, as depicted in FIG. 20, the digital vault may be used to notarize documents. The digital vault may check the identity of the user 2000. If the user is a service provider, the service provider may be able to add content to the content queue. The service provider may also check the content queue and notary queue. The service provider may check content for validation. If valid, the service provider may notarize the content, send an alert, and delete the content from the queue. The notarized content may then be added to the vault and the content's origin may be identified. If the content is not valid, the content may be deleted from the queue and the service provider may send an alert.

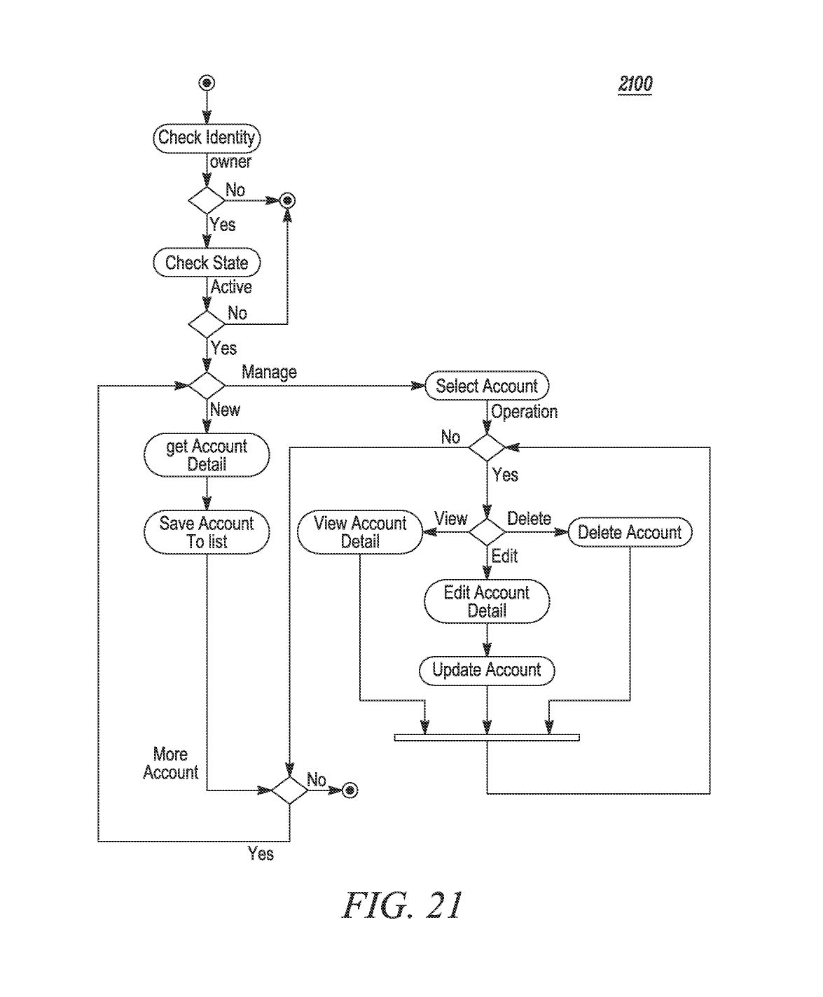

In embodiments, as depicted in FIG. 21, owners may create and/or manage new accounts 2100. Owners may be able to create new accounts and save the account details to a list. Owners may view, edit, or delete the details of existing accounts as well. Owners may be able to create and manage multiple accounts.

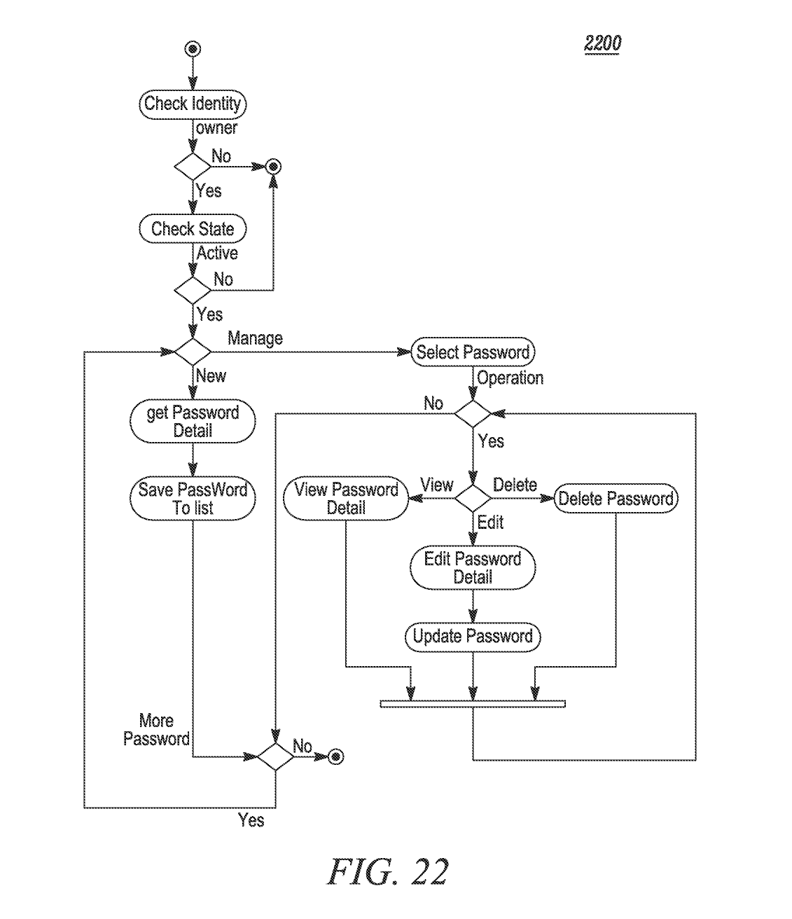

In embodiments, as depicted in FIG. 22, owners may create and/or manage new passwords 2200. Owners may be able to create new passwords and save the password details to a list. Owners may be able to view old passwords, edit or update existing passwords, or delete old passwords. Owners may be able to create and manage multiple passwords.

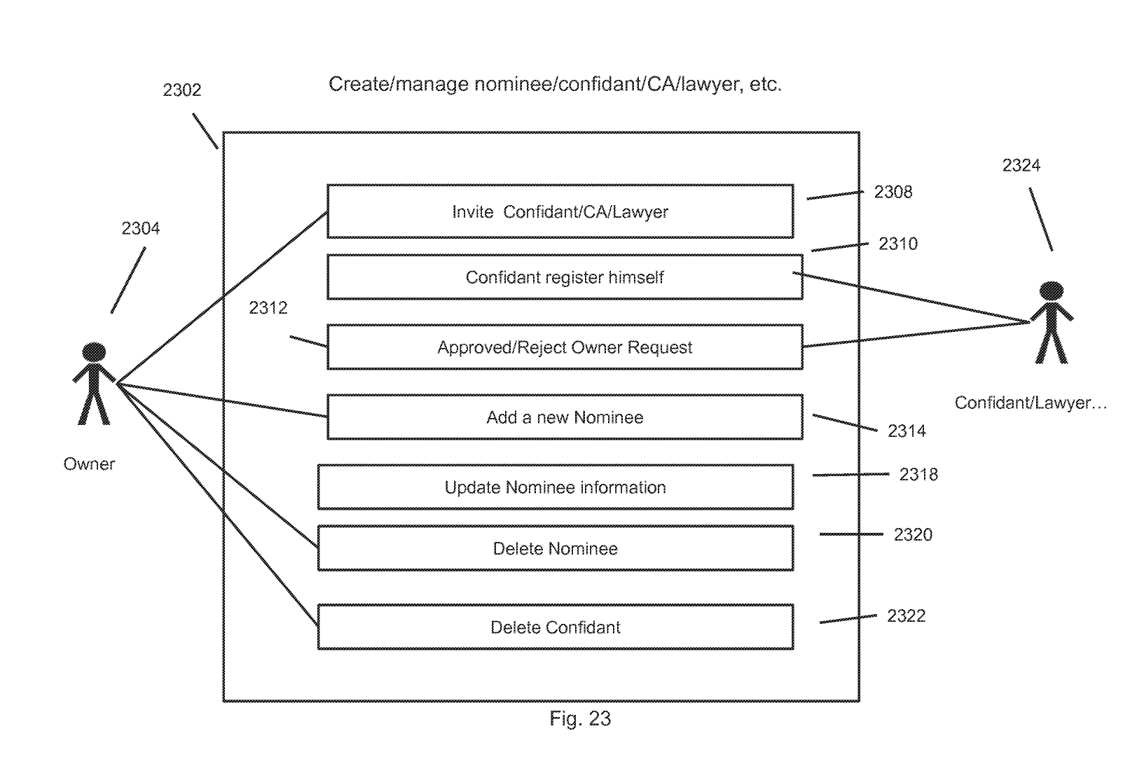

In embodiments and as illustrated in FIG. 23, nominee, confidant, certificate authority, lawyer, and other user creation and management services 2302 may be provided to the owner 2304 and may include confidant/certificate authority/lawyer invitation services 2308, self-registration services 2310, owner request approval or rejection services, 2312, new nominee adding services 2314, nominee information update services 2318, nominee deletion services 2320, and confidant deletion services 2322. Confidants, certificate authorities, nominees, lawyer or other users may be able to access the self-registration services as well as the owner request approval or rejection services.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (e.g., math coprocessor, graphic co-processor, communication co-processor) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein, may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and similar. The cell network may be a GSM, GPRS, 3G, EVDO, LTE, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and similar. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and so forth; other computer memory such as dynamic memory, static memory, read/write storage, mutable storage, read only, random access, sequential access, location addressable, file addressable, content addressable, network attached storage, storage area network, bar codes, magnetic ink, etc.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and so forth. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any nonclaimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed is:

1. A method comprising:
establishing an electronic storage vault to store electronic content related to an individual;
creating a tangible and transferrable receipt for the electronic storage vault, the receipt providing evidence of ownership of the electronic storage vault and allowing access to the electronic storage vault of a person presenting the tangible and transferrable receipt;
managing the electronic content for the individual;
making the content available to at least one authorized stakeholder, the authorized stakeholder being given access to the receipt;
providing content services to the at least one authorized stakeholder; and
transferring the electronic content to the authorized stakeholder upon the occurrence of a life-changing event of the individual and upon presentation of the receipt by the stakeholder.

2. The method of claim 1, wherein the electronic content is selected from the group of metadata relating to physical documents, items in digital form, metadata of digital documents, original physical documents, items in various digital forms and original digital documents.

3. The method of claim 1, wherein the electronic content is associated with physical content.

4. The method of claim 1, wherein the physical content comprises documents.

5. The method of claim 1, wherein the stakeholder is selected from the group consisting of an individual, an executor, a trustee, a guardian, a guardian ad litem, an agent, a health care proxy holder, a nominee, a digital content vault service provider, a service provider, a financial institution, a nominee, a trustee, a digital notary, a submitter, a government and a court.

6. The method of claim 3, wherein the service provider is selected from the group consisting of a notary service provider, certificate authority service provider, a bank, trust company, insurance company, a financial services provider, and a provider of legal services.

7. The method of claim 1, wherein the content services are selected from the group consisting of digital vault services, alert services, digital content services, digital safe services, nomination services, and digital post box services.

8. The method of claim 7, wherein digital vault services are selected from the group consisting of access services, management services, activation services and deactivation services.

9. The method of claim 7, wherein digital content services are selected from the group consisting of create services and manage services.

10. The method of claim 7, wherein digital safe services are selected from the group consisting of access services, create services, nomination services, and manage services.

11. The method of claim 7, wherein digital post box services are selected from the group consisting of access services, add services, and retire contents services.

12. The method of claim 1, wherein the tangible and transferrable receipt comprises a physical object selected from the group consisting of: one or more pieces of paper; and an object.

13. A method comprising:
establishing an electronic storage vault to store electronic content related to an organization;
creating a tangible and transferrable receipt for the electronic storage vault, the receipt providing evidence of ownership of the electronic storage vault and allowing access to the electronic storage vault of a person presenting the tangible and transferrable receipt;
managing the electronic content for the organization;
making the content and the receipt available to at least one authorized stakeholder;
providing content services to the at least one authorized stakeholder; and
transferring the electronic content to the authorized stakeholder upon the occurrence of an authorizing event of the organization and upon presentation of the receipt.

14. The method of claim 13, wherein the electronic content is selected from the group consisting of metadata of physical documents, items in digital form, metadata of digital documents, original physical documents, items in various digital forms and original digital documents.

15. The method of claim 13, wherein the authorizing event is a lawful request from an executive or a board of governors of the organization.

16. The method of claim 13, wherein the authorized stakeholder comprises an executive or a board of governors of the organization.

17. A method comprising:
establishing an electronic storage vault to store electronic content related to an individual or organization;
creating a tangible and transferrable receipt for the electronic storage vault, the receipt providing evidence of ownership of the electronic storage vault and allowing access to the electronic storage vault of a person;
managing the electronic content of the electronic storage vault;
making the content available to at least one authorized stakeholder;
providing content services to the at least one authorized stakeholder; and
transferring the electronic content to the authorized stakeholder upon the occurrence of an authorizing event and upon the presentation of the receipt.

18. The method of claim 17, wherein the stakeholder is selected from the group consisting of an individual, an executor, a trustee, a guardian, a guardian ad litem, an agent, a health care proxy holder, a nominee, a digital content vault service provider, a service provider, a financial institution, a nominee, a trustee, a digital notary, a submitter, a government and a court.

19. The method of claim 17, wherein the electronic vault stores electronic content related to an individual and the authoring event is a contract or a board resolution.

20. The method of claim 17, wherein the electronic storage vault stores electronic content related to an individual and the authorizing event is death or an incapacitating illness of the individual.
